(19) United States
(12) Patent Application Publication
(10) Pub. No.: US 2011/0066372 A1
(43) Pub. Date: Mar. 17, 2011

(54) NAVIGATION DEVICE, NAVIGATION METHOD, AND MOBILE PHONE HAVING NAVIGATION FUNCTION

(75) Inventor: Tatsuya SAKASHITA, Kanagawa (JP)

(73) Assignee: SONY CORPORATION, Tokyo (JP)

(21) Appl. No.: 12/845,250

(22) Filed: Jul. 28, 2010

(30) Foreign Application Priority Data
Sep. 15, 2009 (JP) 2009-213448

(51) Int. Cl. G01C 21/00; G01S 19/42

(52) U.S. Cl. 701/208

(57) ABSTRACT

Provided is a navigation device including position measuring means that measures a present position on the basis of satellite signals; map displaying means that displays a local map; present position notifying means that displays a present position mark on the local map; estimated present position acquiring means that acquires an estimated present position by estimating the present position in a communication environment in which the satellite signals are unreceivable; and control means that reads attribute information about a next link that is next to a present link including the present position and, if the control means determines that the next link is an area in which a reception sensitivity for the satellite signals is low, does not fix the mark and continuously displays the mark on the local map in accordance with the estimated present position after the present position has moved from the present link to the next link.

### BACKGROUND OF THE INVENTION

1. Field of the Invention

The present invention relates to a navigation device, a navigation method, and a mobile phone having a navigation function, which are suitable for, for example, a portable navigation device.

2. Description of the Related Art

Existing navigation devices receive position signals (hereinafter referred to as GPS signals) from a plurality of global positioning system (GPS) satellites and calculate the present position of a vehicle on the basis of the GPS signals.

However, when a vehicle in which the navigation device is placed is in a tunnel or an underground parking garage, it is difficult for the navigation device to receive GPS signals from GPS satellites and to calculate the present position on the basis of the GPS signals.

Even when it is difficult to receive GPS signals, some navigation devices calculate the velocity in the direction of travel of the vehicle on the basis of the acceleration in a horizontal direction perpendicular to the direction of travel and the angular velocity around the vertical axis perpendicular to the direction of travel when the vehicle is cornering, and thereby calculate the present position of the vehicle on the basis of the velocity in the direction of travel (see, for example, Japanese Unexamined Patent Application Publication No. 2008-76389).

Some navigation devices determine whether or not the present position of the vehicle is in a tunnel, and, if the present position is in a tunnel, highlights the tunnel on a map so as to indicate that the vehicle is passing through the tunnel and prevent a user to lose track of the present position (see, for example, Japanese Unexamined Patent Application Publication No. 6-317650).

### SUMMARY OF THE INVENTION

The navigation device described in Japanese Unexamined Patent Application Publication No. 6-317650 only highlights the tunnel so as to indicate that the vehicle is passing through the tunnel, and it is difficult for the navigation device to accurately indicate the present position of the vehicle.

The present invention provides a navigation device, a navigation method, and a mobile phone having a navigation function, which can precisely indicate the present position of a moving body under conditions when it is difficult to receive GPS signals.

According to an embodiment of the present invention, there is provided a navigation device including position measuring means that measures a present position on the basis of satellite signals received from satellites; map displaying means that reads a local map including the present position from storage means and displays the local map on display means; present position notifying means that generates a mark and displays the mark on the local map, the mark representing the present position and having a predetermined shape; estimated present position acquiring means that acquires an estimated present position by estimating the present position in a communication environment in which the satellite signals are unreceivable; and control means that reads attribute information about a next link that is next to a present link including the present position and, if the control means determines that the next link is an area in which a reception sensitivity for the satellite signals is low, does not fix the mark and continuously displays the mark on the local map in accordance with the estimated present position instead of using the present position measured by the position measuring means after the present position has moved from the present link to the next link.

With the navigation device, if it is determined that the next link is an area in which the reception sensitivity for the satellite signals is low, after the present position has moved from the present link to the next link, the mark is not fixed and continues to be displayed on the local map in accordance with the estimated present position, whereby the present position of a moving body can be more accurately displayed than the case in which the mark is fixed and displayed.

According to an embodiment of the present invention, there is provided a navigation method including the steps of measuring a present position on the basis of satellite signals received from satellites by using predetermined position measuring means; reading a local map including the present position from storage means and displaying the local map on display means by using predetermined map reading means; generating and displaying a mark on the local map by using predetermined present position notifying means, the mark representing the present position and having a predetermined shape; acquiring an estimated present position by estimating the present position by using predetermined estimated present position acquiring means in a communication environment in which the satellite signals are unreceivable; and performing control, by using predetermined control means, so as to read attribute information about a next link next to a present link including the present position and, if the control means determines that the next link is an area in which a reception sensitivity for the satellite signals is low, so as not to fix the mark and so as to continuously display the mark on the local map in accordance with the estimated present position instead of using the present position measured by the position measuring means after the present position has moved from the present link to the next link.

With the method, if it is determined that the next link is an area in which the reception sensitivity for the satellite signals is low, after the present position has moved from the present link to the next link, the mark is not fixed and continues to be displayed on the local map in accordance with the estimated present position, whereby the present position of a moving body can be more accurately displayed than the case in which the mark is fixed and displayed.

According to an embodiment of the present invention, there is provided a mobile phone having a navigation function, the mobile phone including a mobile phone unit; and a navigation device including position measuring means that measures a present position on the basis of satellite signals received from satellites, map displaying means that reads a local map including the present position from storage means and displays the local map on display means, present position notifying means that generates a mark and displays the mark on the local map, the mark representing the present position and having a predetermined shape, estimated present position acquiring means that acquires an estimated present position by estimating the present position in a communication environment in which the satellite signals are unreceivable, and control means that reads attribute information about a next link that is next to a present link including the present position and, if the control means determines that the next link is an area in which a reception sensitivity for the satellite signals is low, does not fix the mark and continuously displays the mark on the local map in accordance with the estimated present position instead of using the present position measured by the position measuring means after the present position has moved from the present link to the next link.

With the mobile phone having the navigation function, if it is determined that the next link is an area in which the reception sensitivity for the satellite signals is low, after the present position has moved from the present link to the next link, the mark is not fixed and continues to be displayed on the local map in accordance with the estimated present position, whereby the present position of a moving body can be more accurately displayed than the case in which the mark is fixed and displayed.

The embodiments of the present invention realize a navigation device, a navigation method, and a mobile phone having a navigation function, with which, if it is determined that the next link is an area in which the reception sensitivity for the satellite signals is low, after the present position has moved from the present link to the next link, the mark is not fixed and continues to be displayed on the local map in accordance with the estimated present position, whereby the present position of a moving body can be more accurately displayed than the case in which the mark is fixed and displayed.

### BRIEF DESCRIPTION OF THE DRAWINGS

FIG. 1 is a diagram illustrating the overall structure of a PND;

FIG. 2 is a diagram illustrating the definition of the coordinate system associated with the PND;

FIG. 3A is a diagram illustrating a vehicle traveling on a concave road surface, and FIG. 3B is a diagram illustrating the vehicle traveling on a convex road surface;

FIG. 4 is a diagram illustrating a vehicle traveling along a curve;

FIG. 5 is a diagram illustrating a method of calculating the present position using a velocity and an angle;

FIG. 6 is a diagram illustrating sensors included in the PND;

FIG. 7 is a block diagram illustrating of the circuit structure of the PND;

FIG. 8 is a block diagram illustrating the structure of a velocity calculator;

FIG. 9 is graph illustrating the relationship between a height and an angle;

FIGS. 10A and 10B are graphs illustrating the angle of a road surface when a vehicle is traveling at a low velocity;

FIGS. 11A and 11B are graphs illustrating the angle of a road surface when a vehicle is traveling at a high velocity;

FIG. 12 is a graph illustrating the angle of a road surface when a vehicle is traveling at a very low velocity;

FIG. 13 is a diagram illustrating a vibration due to a cradle;

FIG. 14 is a graph illustrating a total acceleration and a total angular velocity after being high pass filtered;

FIGS. 15A to 15H are graphs illustrating the total angular velocity that has been Fourier transformed for every 4096 data points;

FIGS. 16A to 16H are graphs illustrating the total acceleration that has been Fourier transformed for every 4096 data points;

FIGS. 17A to 17D are graphs illustrating a comparison of low pass filtering performed on the total acceleration;

FIGS. 18A to 18D are graphs illustrating a comparison of low pass filtering performed on the total angular velocity;

FIG. 19 is a graph illustrating the relationship between a front acceleration and a rear acceleration when the vehicle is traveling at a low velocity;

FIGS. 20A and 20B are graphs illustrating the relationship between the front acceleration and the rear acceleration when the vehicle is traveling at a medium velocity and at a high velocity;

FIGS. 21A to 21F are graphs illustrating a simulation result of the acceleration, the pitch rate, and the velocity when the PND is placed at three different positions;

FIG. 22 is a graph illustrating the relationship between the maximum value and the minimum value;

FIG. 23 is a graph illustrating the relationship between the velocity and the number of data points;

FIGS. 24A and 24B are diagrams illustrating accelerations and pitch rates for arcs having different lengths;

FIG. 25 is a flowchart illustrating a process of calculating the present position using velocity calculation;

FIGS. 26A and 26B are diagrams illustrating display control that fixes the present position mark in a tunnel;

FIGS. 27A and 27B are diagrams illustrating display control that does not fix the present position mark in the tunnel;

FIG. 28 is a flowchart illustrating a process of controlling the display of the present position mark; and

FIG. 29 is a block diagram illustrating the circuit structure of a mobile phone having a navigation function according to another embodiment.

### DESCRIPTION OF THE PREFERRED EMBODIMENT

Hereinafter, embodiments for carrying out the present invention (hereinafter referred to as embodiments) will be described in the following order with reference to the drawings.

### 1. Embodiment

### 2. Other Embodiments

### 1. Embodiment

### 1-1. External Structure of PND

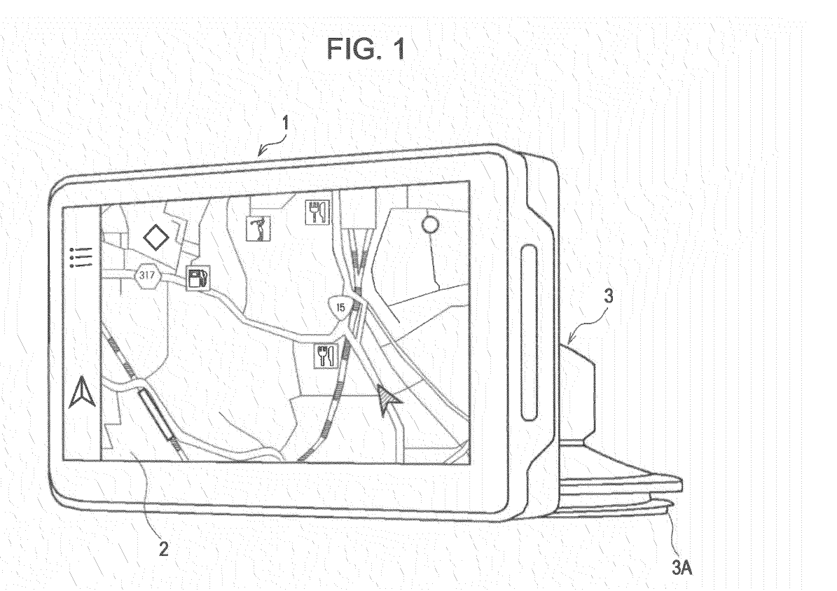

FIG. 1 illustrates a portable navigation device 1 (hereinafter referred to as the PND 1) according to an embodiment of the present invention. The PND 1 has a display 2 on a front surface thereof. The display 2 can display a map image corresponding to map data stored in, for example, a nonvolatile memory (not shown) of the PND 1.

The PND 1 is supported by and is mechanically and electrically connected to a cradle 3 that is attached to a dashboard of a vehicle with a suction cup 3A.

Thus, the PND 1 operates using electric power supplied by a battery of the vehicle through the cradle 3. When the PND 1 is detached from the cradle 3, the PND 1 operates using electric power supplied by an internal battery.

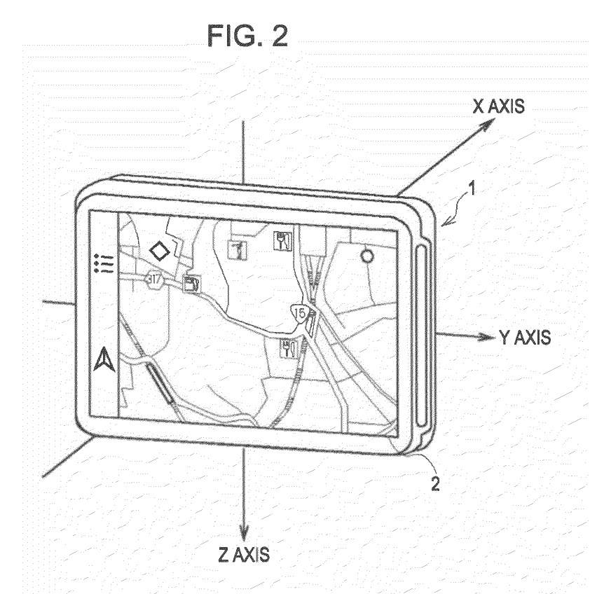

The PND 1 is disposed so that the display 2 extends perpendicular to the direction of travel of the vehicle. FIG. 2 illustrates the coordinate system associated with the PND 1. The X axis extends in the front-back direction of the vehicle, the Y axis extends in a horizontal direction perpendicular to the X axis, and the Z axis extends in the vertical direction.

In the coordinate system, the direction of travel of the vehicle is defined as the positive direction along the X axis, the rightward direction is defined as the positive direction along the Y axis, and the downward direction is defined as the positive direction along the Z axis.

### 1-2. Principle of Velocity Calculation

The fundamental principle used by the PND 1 to calculate the velocity of a vehicle on which the PND 1 is mounted will be described.

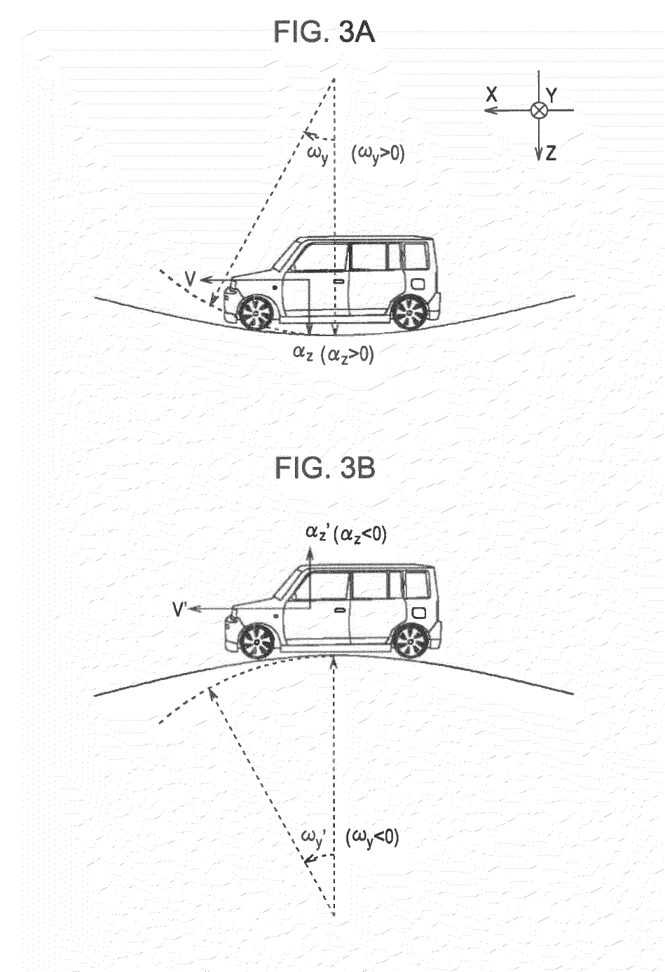

In practice, a road on which a vehicle travels is seldom flat, and is generally concave as illustrated in FIG. 3A or generally convex as illustrated in FIG. 3B.

In the coordinate system associated with the vehicle, the X axis extends in the front-back direction, the Y axis extends in a horizontal direction perpendicular to the X axis, and the Z axis extends in the vertical direction.

The PND 1 (not shown) is placed, for example, on the dashboard of the vehicle. When the vehicle travels on the concave road (FIG. 3A), a three-axis acceleration sensor of the PND 1 detects a downward acceleration α_{z} along the Z axis with a sampling frequency of, for example, 50 Hz.

A Y axis gyro sensor of the PND 1 detects an angular velocity ω_{y} around the Y axis (hereinafter referred to as a pitch rate) perpendicular to the direction of travel of the vehicle with a sampling frequency of, for example, 50 Hz.

For the PND 1, the sign of the downward acceleration α_{z} along the Z axis is defined as positive. The sign of the pitch rate ω_{y} upwardly rotating, with respect to the direction of travel, along an imaginary circle that is formed along a concave road surface illustrated in FIG. 3A is defined as positive.

The PND 1 calculates the velocity of the vehicle in the direction of travel (hereinafter referred to as an autonomous velocity V) 50 times per second using the acceleration α_{z} detected by the three-axis acceleration sensor and the pitch rate ω_{y} detected by the Y axis gyro sensor in accordance with the following equation (1).

$$V = \frac{{α}_{z}}{{ω}_{y}} \qquad ( 1 )$$

When the vehicle travels on a convex road (FIG. 3B), the three-axis acceleration sensor of the PND 1 detects an upward acceleration α_{z′} along the Z axis with a sampling frequency of, for example, 50 Hz, and the Y axis gyro sensor of the PND 1 detects a pitch rate ω_{y′} around the Y axis with a sampling frequency of, for example, 50 Hz.

The PND 1 calculates the autonomous velocity V′ of the vehicle in the direction of travel 50 times per second using the acceleration α_{z′} detected by the three-axis acceleration sensor and the pitch rate ω_{y′} detected by the Y axis gyro sensor in accordance with the following equation (2).

$${V}^{′} = \frac{{α}_{z}^{′}}{{ω}_{y}^{′}} \qquad ( 2 )$$

For convenience of description here, a negative acceleration is described as the acceleration α_{z′}. In practice, the three-axis acceleration sensor detects the acceleration α_{z′} as a negative value of the acceleration α_{z}. Likewise, a negative pitch rate is described as the pitch rate ω_{y′}. In practice, the Y axis gyro sensor detects the pitch rate ω_{y′} as a negative value of the pitch rate ω_{y}. Therefore, in practice, the autonomous velocity V′ is also calculated as the autonomous velocity V.

### 1-3. Principle of Calculating Present Position

Next, the principle of calculating the present position on the basis of the autonomous velocity V, which have been calculated by using the above principle of velocity calculation, and the angular velocity around the Z axis will be described.

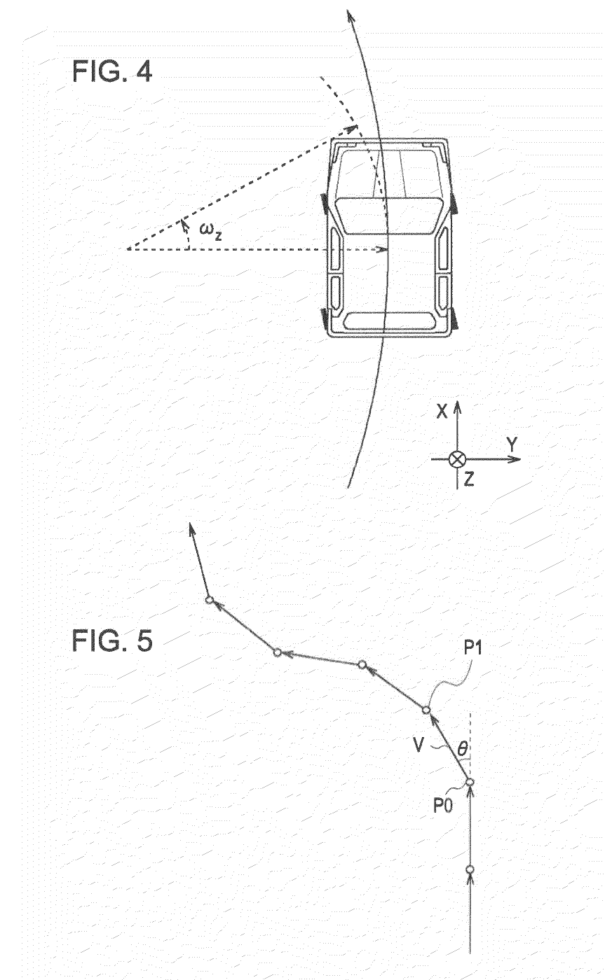

Referring to FIG. 4, when the vehicle is, for example, turning to the left, a Z axis gyro sensor of the PND 1 detects an angular velocity around the Z axis (hereinafter referred to as a yaw rate) ω_{z} with a sampling frequency of, for example, 50 Hz.

Referring to FIG. 5, the PND 1 calculates the displacement from a previous position P0 to a present position P1 on the basis of the autonomous velocity V at the previous position P0 and an angle θ that is calculated by multiplying the yaw rate ω_{z} detected by the gyro sensor by a sampling period (in this case, 0.02 s). The PND 1 calculates the present position P1 by adding the displacement to the previous position P0.

### 1-4. Sensor Structure of PND

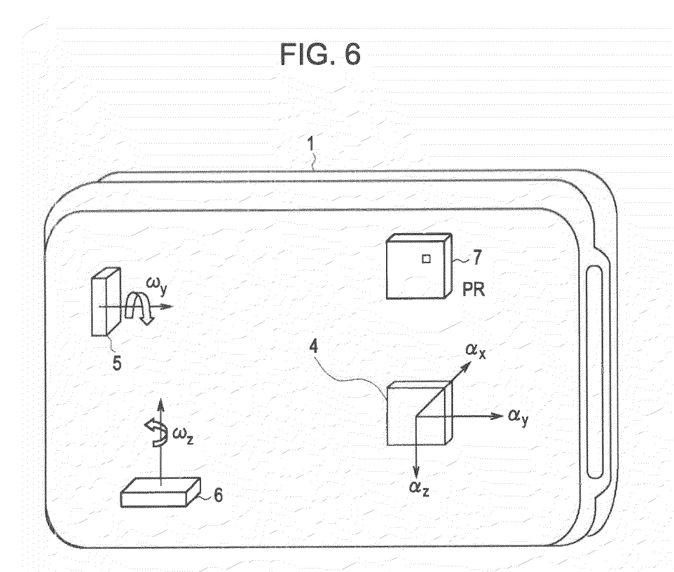

Referring to FIG. 6, the PND 1 includes a three-axis acceleration sensor 4, a Y axis gyro sensor 5, a Z axis gyro sensor 6, and a barometric pressure sensor 7.

The three-axis acceleration sensor 4 detects an acceleration αₓ along the X-axis, an acceleration α_{y} along the Y-axis, and the acceleration α_{z} along the Z-axis respectively as voltages.

The Y axis gyro sensor 5, the Z axis gyro sensor 6, and the barometric pressure sensor 7 respectively detect the pitch rate ω_{y} around the Y axis, the yaw rate ω_{z} the around the Z axis, and an ambient pressure PR respectively as voltages.

### 1-5. Circuit Structure of PND

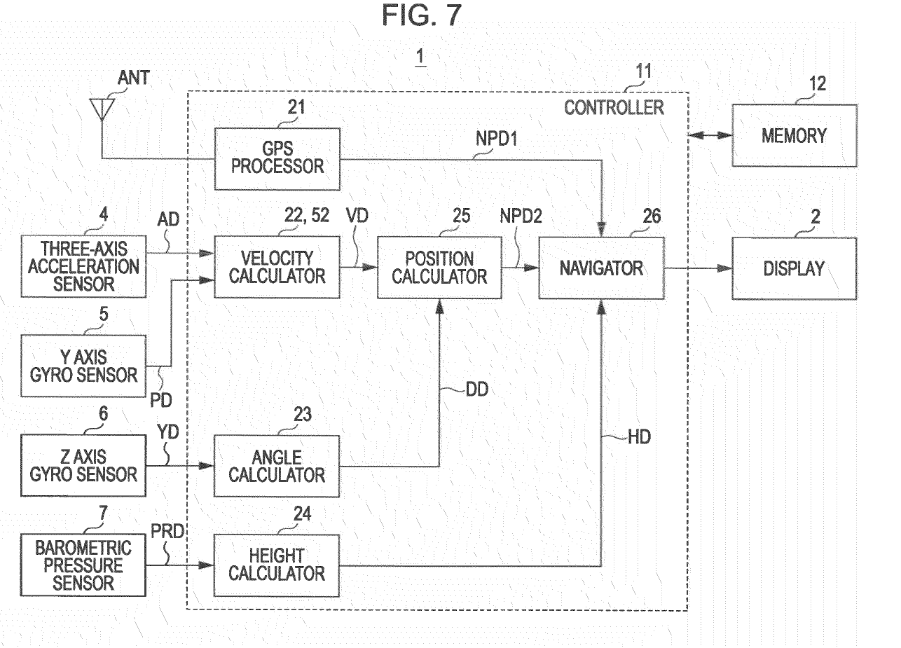

Referring to FIG. 7, a controller 11 of the PND 1, which is a central processing unit (CPU), controls the PND 1 in accordance with an operating system that is read from a memory 12 that includes a nonvolatile memory.

In the PND 1, the controller 11 performs velocity calculation and other processes described below in accordance with various application programs that are read from the memory 12.

In order to perform the velocity calculation and other processes, the controller 11 includes, as functional blocks, a GPS processor 21, a velocity calculator 22, an angle calculator 23, a height calculator 24, a position calculator 25, and a navigator 26.

A GPS antenna ANT of the PND 1 receives GPS signals from GPS satellites, and the GPS signals are sent to the GPS processor 21 of the controller 11.

The GPS processor 21 obtains present position data NPD1 by accurately measuring the present position of the vehicle on the basis of orbit data obtained by demodulating the GPS signals and data on the distances between the GPS satellites and the vehicle, and sends the present position data NPD1 to the navigator 26.

The navigator 26 reads map data of a region including the present position of the vehicle from the memory 12 on the basis of the present position data NPD1, and generates a map image including the present position, outputs the map image to the display 2, and thereby displays the map image.

The three-axis acceleration sensor 4 detects the accelerations αₓ, α_{y} and α_{z} with a sampling frequency of, for example, 50 Hz, and sends acceleration data AD that represents the acceleration α_{z} to the velocity calculator 22 of the controller 11.

The Y axis gyro sensor 5 detects the pitch rate ω_{y} with a sampling frequency of, for example, 50 Hz, and sends pitch rate data PD that represents the pitch rate ω_{y} to the velocity calculator 22 of the controller 11.

The velocity calculator 22 calculates the autonomous velocity V 50 times per second in accordance with equation (1) using of the acceleration α_{z}, which corresponds to the acceleration data AD supplied by the three-axis acceleration sensor 4, and the pitch rate ω_{y}, which corresponds to the pitch rate data PD supplied by the Y axis gyro sensor 5, and sends velocity data VD that represents the autonomous velocity V to the position calculator 25.

The Z axis gyro sensor 6 detects the yaw rate ω_{z} at a sampling frequency of, for example, 50 Hz, and sends yaw rate data YD that represents the yaw rate ω_{z} to the angle calculator 23 of the controller 11.

The angle calculator 23 calculates the angle θ with which the vehicle turns to the right or to the left by multiplying the yaw rate ω_{z}, which corresponds to the yaw rate data YD supplied by the Z axis gyro sensor 6, by a sampling period (in this case, 0.02 s), and sends angle data DD that represents the angle θ to the position calculator 25.

The position calculator 25 calculates the displacement from the previous position P0 to the present position P1 illustrated in FIG. 5 on the basis of the autonomous velocity V, which corresponds to the velocity data VD supplied by the velocity calculator 22, and the angle θ, which corresponds to the angle data DD supplied by the angle calculator 23.

The position calculator 25 calculates the present position P1 by adding the displacement to the previous position P0, and sends present position data NPD2, which represents the present position P1, to the navigator 26.

The barometric pressure sensor 7 detects the ambient pressure PR with a sampling frequency of, for example, 50 Hz, and sends barometric pressure data PRD that represents the barometric pressure PR to the height calculator 24.

The height calculator 24 calculates the height of the vehicle on the basis of the barometric pressure PR, which corresponds to the barometric pressure data PRD supplied by the barometric pressure sensor 7, and sends height data HD that represents the height of the vehicle to the navigator 26.

The navigator 26 reads map data of a region including the present position of the vehicle from the memory 12 on the basis of the present position data NPD2 supplied by the position calculator 25 and the height data HD supplied by the height calculator 24, generates a map image including the present position, outputs the map image to the display 2, and thereby displays the map image.

### 1-6. Autonomous Velocity Calculation Process

Next, an autonomous velocity calculation process performed by the velocity calculator 22 will be described in detail. In this process, the velocity calculator 22 calculates the autonomous velocity V on the basis of the acceleration α_{z}, which corresponds to the acceleration data AD supplied by the three-axis acceleration sensor 4, and the pitch rate ω_{y}, which corresponds to the pitch rate data PD supplied by the Y axis gyro sensor 5.

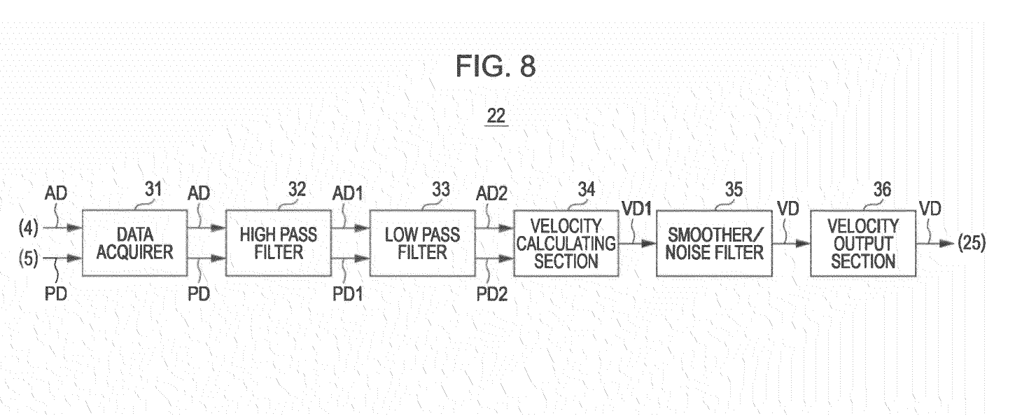

Referring to FIG. 8, in order to perform the autonomous velocity calculation, the velocity calculator 22 includes, as functional blocks, a data acquirer 31, a high pass filter 32, a low pass filter 33, a velocity calculating section 34, a smoother/noise filter 35, and a velocity output section 36.

The data acquirer 31 of the velocity calculator 22 acquires the acceleration data AD supplied by the three-axis acceleration sensor 4 and the pitch rate data PD supplied by the Y axis gyro sensor 5, and sends the acceleration data AD and the pitch rate data PD to the high pass filter 32.

The high pass filter 32 removes direct-current components from the acceleration data AD and the pitch rate data PD, which are supplied by the data acquirer 31, to generate acceleration data AD1 and pitch rate data PD1, and sends the acceleration data AD1 and the pitch rate data PD1 to the low pass filter 33.

The low pass filter 33 performs low pass filtering (described below) on the acceleration data AD1 and the pitch rate data PD1, which are supplied by the high pass filter 32, to generate acceleration data AD2 and pitch rate data PD2, and sends the acceleration data AD2 and the pitch rate data PD2 to the velocity calculating section 34.

The velocity calculating section 34 performs velocity calculation (described below) using the acceleration data AD2 and the pitch rate data PD2, which are supplied by the low pass filter 33, to generate velocity data VD1, and sends the velocity data VD1 to the smoother/noise filter 35.

The smoother/noise filter 35 performs smoothing and noise filtering (described below) on the velocity data VD1, which is supplied by the velocity calculating section 34, to generate velocity data VD, and sends the velocity data VD to the velocity output section 36.

The velocity output section 36 sends the velocity data VD, which is supplied by the smoother/noise filter 35 and represents the autonomous velocity V of the vehicle, to the position calculator 25.

Thus, the velocity calculator 22 calculates the autonomous velocity V of the vehicle on the basis of the acceleration data AD supplied by the three-axis acceleration sensor 4 and the pitch rate data PD supplied by the Y axis gyro sensor 5.

### 1-7. Low Pass Filtering

Next, low pass filtering, which is performed by the low pass filter 33 on the acceleration data AD1 and the pitch rate data PD1 supplied by the high pass filter 32, will be described in detail.

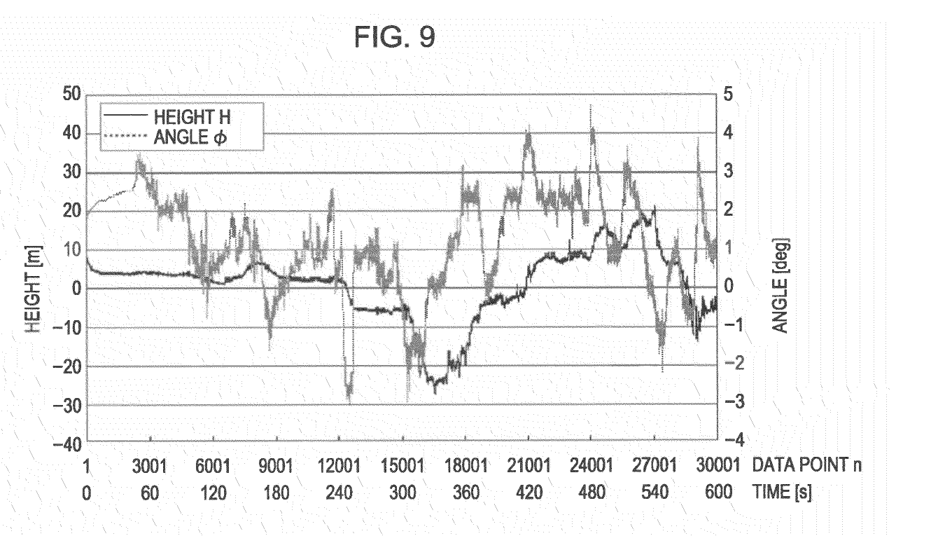

FIG. 9 illustrates the relationship between a height H, which is based on the barometric pressure PR corresponding to the barometric pressure data PRD obtained by the barometric pressure sensor 7, and an angle φ around the Y axis with respect to a horizontal direction, which is based on the pitch rate ω_{y} corresponding to the pitch rate data PD obtained by the Y axis gyro sensor 5. Regarding the angle φ, the upward direction with respect to the direction of travel (the X axis) is defined as positive.

Referring to FIG. 9, there is a correlation between the height H and the angle φ as can be seen from the fact that when the height H sharply decreases from about the 12001st data point (240 s), i.e., when the vehicle travels downhill, the angle φ sharply decreases from about 0.5 deg to about −2.5 deg.

When the height H changes, the angle φ changes in accordance with the change in the height H. Thus, the PND 1 can detect the undulation of a road surface in the direction of travel of the vehicle using the Y axis gyro sensor 5.

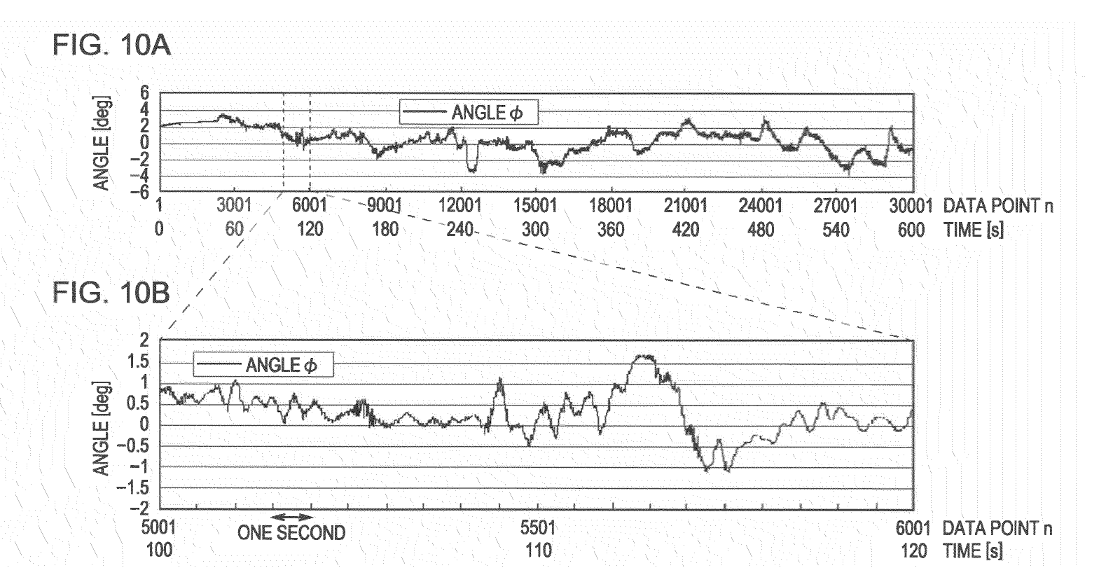

FIG. 10A illustrates the angle φ of FIG. 9. FIG. 10B illustrates the angle φ of FIG. 10A from the 5001st data point to the 6001st data point. During this time, the vehicle travels at a low velocity that is lower than 20 km/h. As can be seen from FIG. 10B, the angle φ oscillates once to twice per second.

Thus, when a vehicle is traveling at a low velocity lower than 20 km/h, the PND 1 mounted on the vehicle detects the angle φ, which is based on the pitch rate ω_{y} corresponding to the pitch rate data PD obtained by the Y axis gyro sensor 5, as an oscillation having a frequency in the range of 1 to 2 Hz.

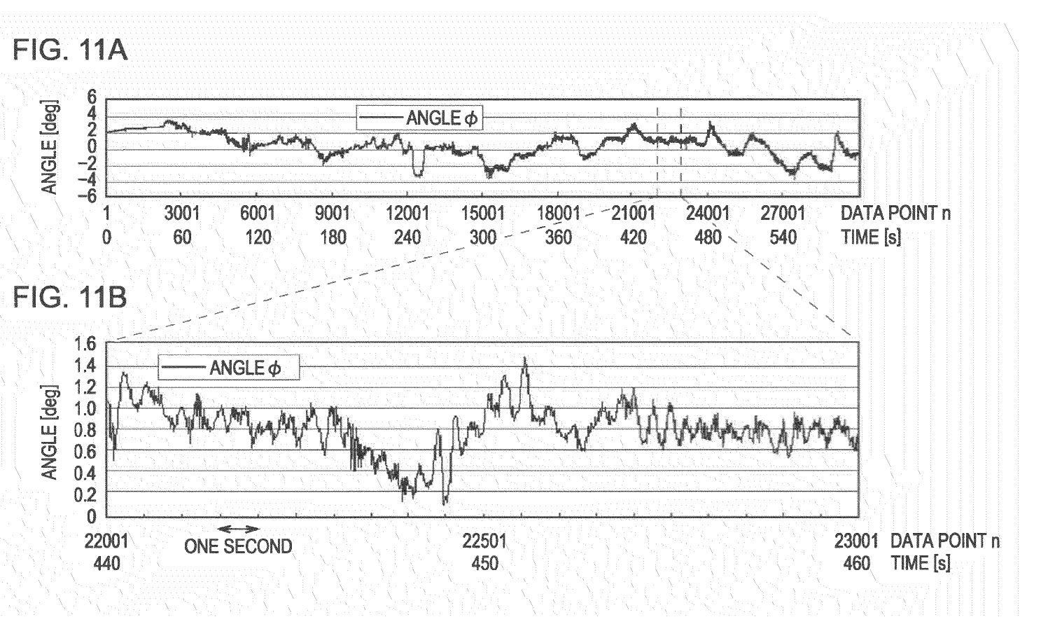

As with FIG. 10A, FIG. 11A illustrates the angle φ of FIG. 9. FIG. 11B illustrates the angle φ of FIG. 11A from the 22001st data point to the 23001st data point. During this time, the vehicle travels at a high velocity that is higher than 60 km/h.

As can be seen from FIG. 11B, when the vehicle is traveling at a high velocity higher than 60 km/h, the PND 1 also detects the angle φ, which is based on the pitch rate ω_{y} corresponding to the pitch rate data PD obtained by the Y axis gyro sensor 5, as an oscillation having a frequency in the range of 1 to 2 Hz.

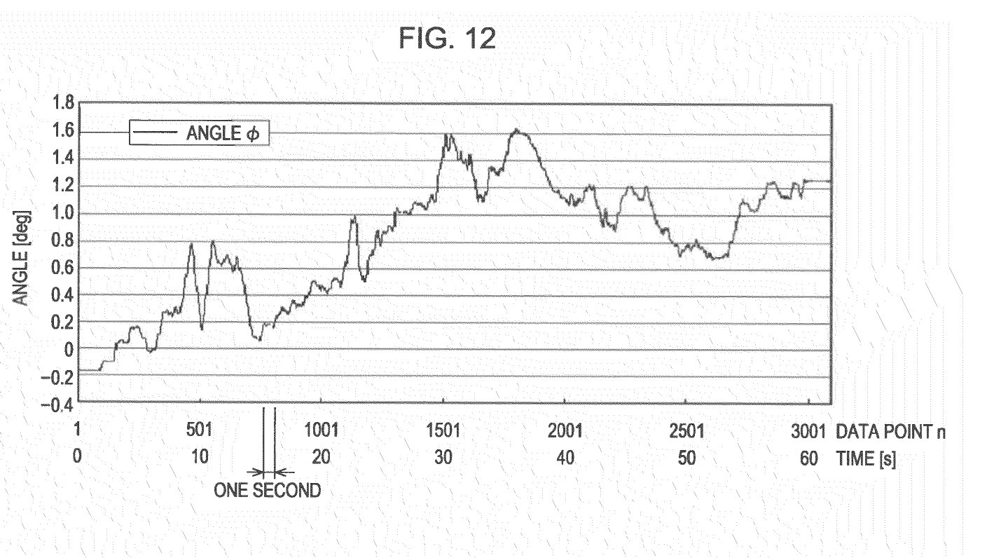

Moreover, as illustrated in FIG. 12, when the vehicle is traveling at a very low velocity that is lower than 10 km/h, the PND 1 also detects the angle φ, which is based on the pitch rate ω_{y} corresponding to the pitch rate data PD obtained by the Y axis gyro sensor 5, as an oscillation having a frequency in the range of 1 to 2 Hz.

Therefore, using the Y axis gyro sensor 5, the PND 1 detects the pitch rate ω_{y} as an oscillation having a frequency in the range of 1 to 2 Hz irrespective of the velocity of the vehicle.

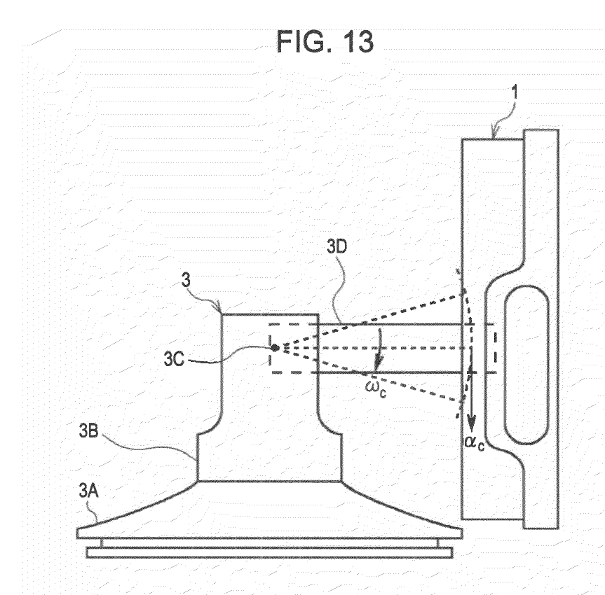

The PND 1 is supported by the cradle 3, which is attached to the dashboard of the vehicle with the suction cup 3A. Referring to FIG. 13, the cradle 3 includes a body 3B, which is disposed on the suction cup 3A, and a PND supporter 3D. One end of the PND supporter 3D is supported by the body 3B at a support point 3C that is located at a predetermined height, and the PND 1 is supported by the PND supporter 3D at the other end of the PND supporter 3D.

Therefore, when the vehicle vibrates due to the undulation of a road surface, the PND 1 vibrates up an down around the support point 3C of the PND supporter 3D with, for example, an acceleration α_{c} and an angular velocity ω_{c}.

Therefore, in practice, the three-axis acceleration sensor 4 detects an acceleration (hereinafter referred to as a total acceleration) α_{cz} that is the sum of the acceleration α_{z} along the Z axis (FIG. 1), which is generated by the vibration of the vehicle due to the undulation of the road surface, and the acceleration α_{c}, which is generated by the vibration of the PND 1 around the support point 3C of the PND supporter 3D.

The Y axis gyro sensor 5 detects an angular velocity (hereinafter referred to as a total angular velocity) ω_{cy} that is the sum of the pitch rate ω_{y} around the Y axis (FIG. 1), which is generated by the vibration of the vehicle due to the undulation of the road surface, and the angular velocity ω_{c}, which is generated by the vibration of the PND 1 around the support point 3C of the PND supporter 3D.

Therefore, the low pass filter 33 acquires the acceleration data AD1, which represents the total angular velocity ω_{cy}, and the pitch rate data PD1, which represents the total acceleration α_{cz}, through the data acquirer 31 and the high pass filter 32.

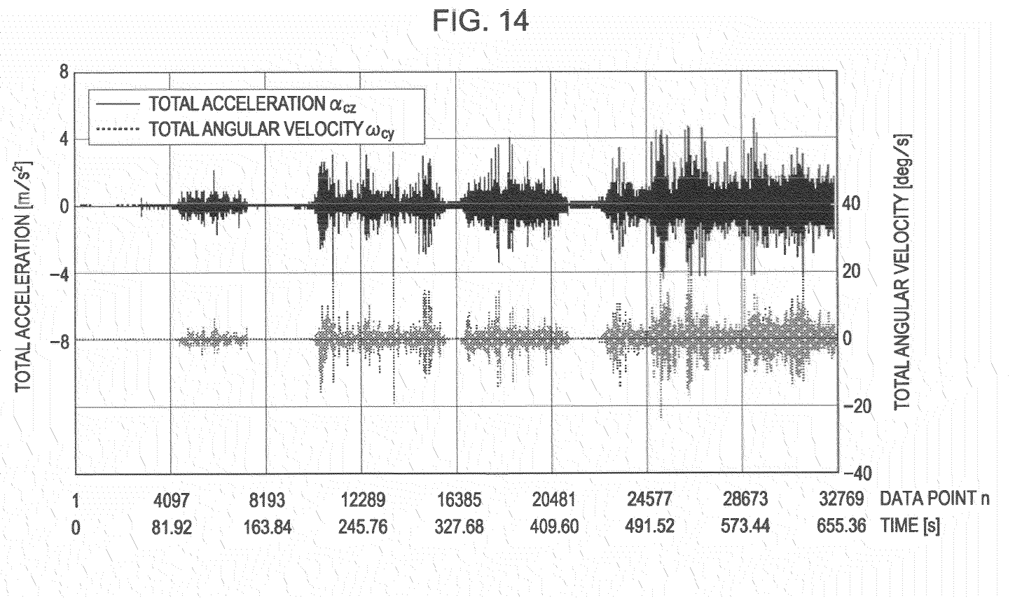

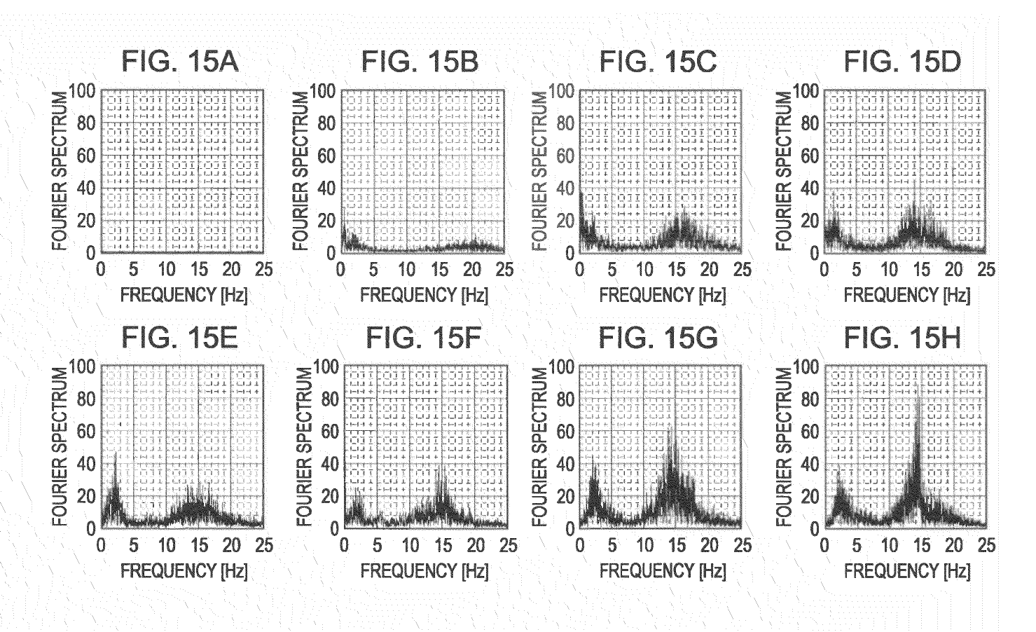

FIG. 14 illustrates the total acceleration α_{cz} and the total angular velocity ω_{cy}, which respectively correspond to the acceleration data AD1 and the pitch rate data PD1 that have been high pass filtered by the high pass filter 32. FIGS. 15A to 15F are graphs illustrating the total angular velocity ω_{cy} of FIG. 14, which has been Fourier transformed for every 4096 data points.

In particular, FIG. 15A is a graph of the total angular velocity ω_{cy} of FIG. 14 from the 1st data point to the 4096th data point, which has been Fourier transformed. Likewise, FIGS. 15B, 15C, and 15D are graphs of the total angular velocity ω_{cy} of FIG. 14 from the 4097th data point to the 8192nd data point, the 8193rd data point to the 12288th data point, and the 12289th data point to the 16384th data point, respectively, each of which has been Fourier transformed.

FIGS. 15E, 15F, 15G, and 15H, are graphs of the total angular velocity ω_{cy} of FIG. 14 from the 16385th data point to the 20480th data point, the 20481st data point to the 24576th data point, the 24577th data point to the 28672nd data point, and the 28673rd data point to the 32768th data point, respectively, each of which has been Fourier transformed.

As can be clearly seen from FIGS. 15C to 15H, a frequency component in the range of 1 to 2 Hz and a frequency component of about 15 Hz have large values.

That is, the Y axis gyro sensor 5 of the PND 1 detects the total angular velocity ω_{cy} that is the sum of the pitch rate ω_{y}, which oscillates with a frequency in the range of 1 to 2 Hz due to the aforementioned undulation of the road surface, and the angular velocity ωₓ, which oscillates with a frequency of about 15 Hz due to the cradle 3 that supports the PND 1.

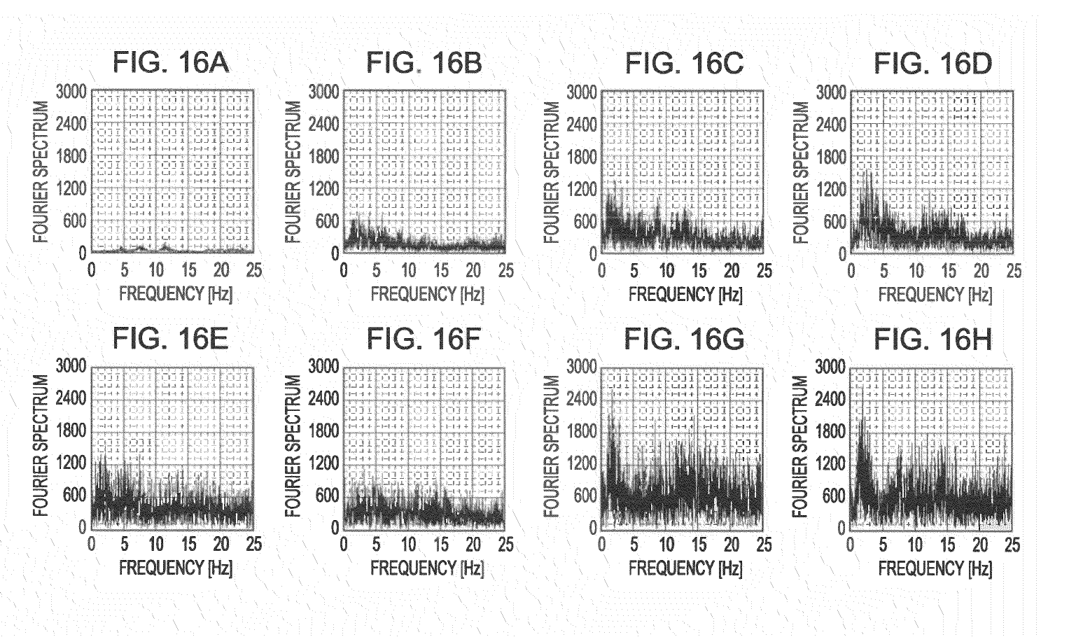

FIGS. 16A to 16F are graphs illustrating the total acceleration α_{cz} of FIG. 14, which has been Fourier transformed for every 4096 data points.

In particular, FIG. 16A is a graph of the total acceleration α_{cz} of FIG. 14 from the 1st data point to the 4096th data point, which has been Fourier transformed. Likewise, FIGS. 16B, 16C, and 16D are graphs of the total acceleration α_{cz} of FIG. 14 from the 4097th data point to the 8192nd data point, the 8193rd data point to the 12288th data point, and the 12289th data point to the 16384th data point, respectively, each of which has been Fourier transformed.

FIGS. 16E, 16F, 16G, and 16H, are graphs of the total acceleration α_{cz} of FIG. 14 from the 16385th data point to the 20480th data point, the 20481st data point to the 24576th data point, the 24577th data point to the 28672nd data point, and the 28673rd data point to the 32768th data point, respectively, each of which has been Fourier transformed.

Considering the fact that the total angular velocity ω_{cy} (FIGS. 15C to 15H) has the frequency component in the range of 1 to 2 Hz and the frequency component of about 15 Hz, it is estimated that the total acceleration α_{cz} also has a frequency component in the range of 1 to 2 Hz and a frequency component of about 15 Hz.

That is, the three-axis acceleration sensor 4 of the PND 1 detects the total acceleration α_{cz}, which is the sum of the acceleration α_{z}, which oscillates with a frequency in the range of 1 to 2 Hz due to the aforementioned undulation of the road surface, and the acceleration α_{c}, which oscillates with a frequency of about 15 Hz due to the cradle 3 that support the PND 1.

Therefore, the low pass filter 33 performs low pass filtering on the acceleration data AD1 and the pitch rate data PD1, which are supplied by the high pass filter 32, so as to remove the frequency component of about 15 Hz, i.e., the acceleration α_{c} and the angular velocity ω_{c} that are generated due to the cradle 3 that supports the PND 1.

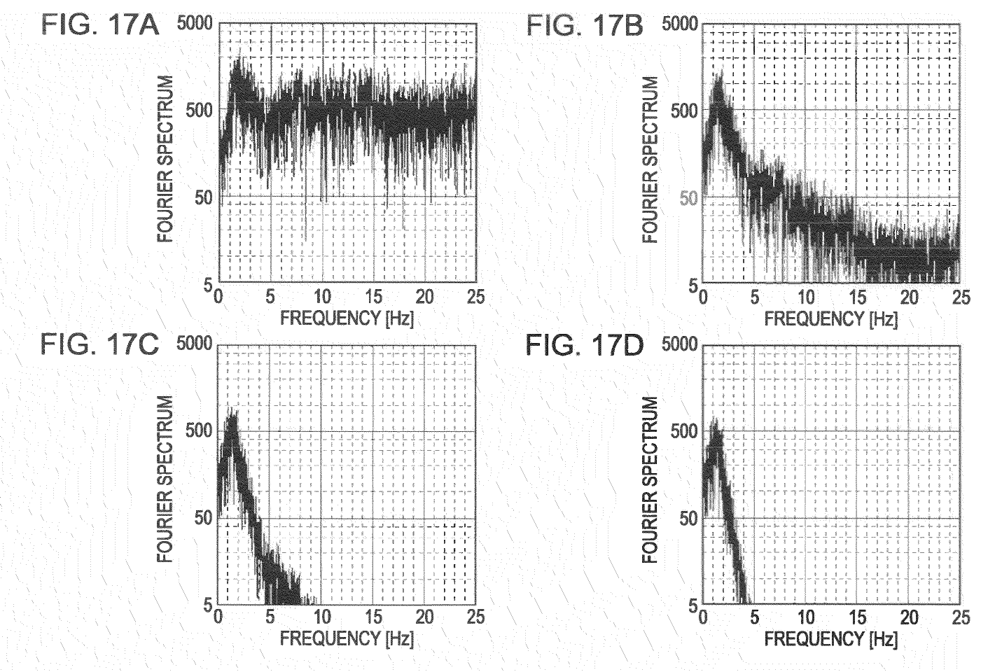

FIG. 17A is a graph of data that is the same as that of FIG. 16H, which is plotted with a logarithmic vertical axis. FIGS. 17B, 17C and 17D are graphs of the total acceleration α_{cz} from the 28673rd data point to the 32768th data point, on which infinite impulse response (IIR) filtering with a cutoff frequency of 2 Hz has been performed twice, four times, and six times, respectively, and on which Fourier transformation has been performed.

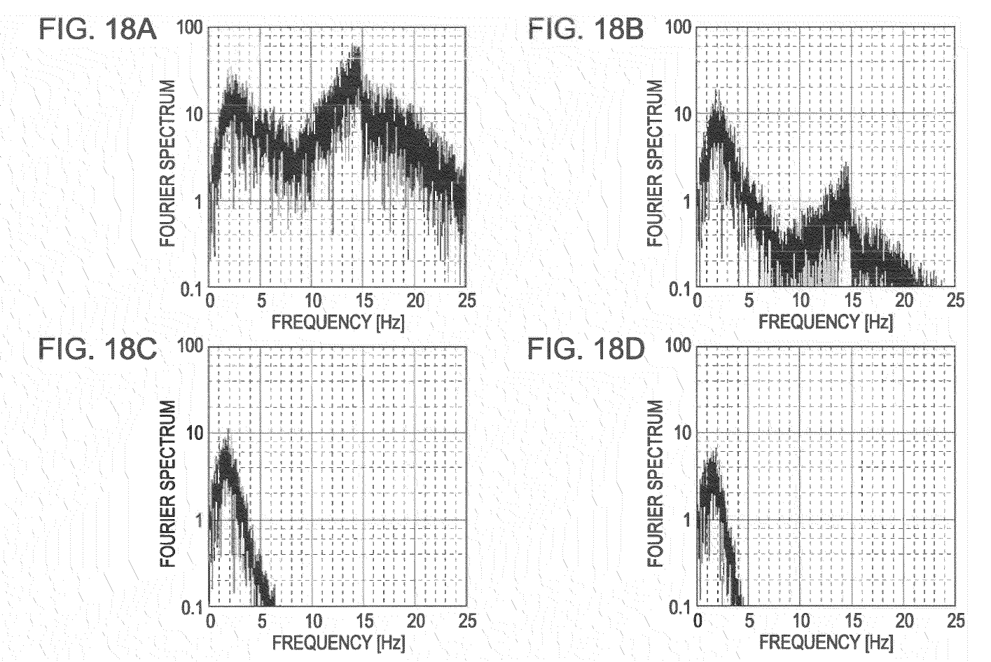

FIG. 18A is a graph of data that is the same as that of FIG. 15H, which is plotted with a logarithmic vertical axis. FIGS. 18B, 18C and 18D are graphs of the total angular velocity ω_{cy} from the 28673rd data point to the 32768th data point, on which infinite impulse response (IIR) filtering with a cutoff frequency of 2 Hz is performed twice, four times, and six times, respectively, and on which Fourier transformation is performed.

As can be seen from FIGS. 17B to 17D and FIGS. 18B to 18D, the PND 1 can remove the frequency component of about 15 Hz from the acceleration data AD1 and the pitch rate data PD1, which are supplied by the high pass filter 32, by performing the IIR filtering with a cutoff frequency of 2 Hz four times or more on the acceleration data AD1 and the pitch rate data PD1.

Therefore, the low pass filter 33 according to the embodiment performs the IIR filtering with a cutoff frequency of 2 Hz four times on the acceleration data AD1 and the pitch rate data PD1, which are supplied by the high pass filter 32, to generate acceleration data AD2 and pitch rate data PD2, and sends the acceleration data AD2 and the pitch rate data PD2 to the velocity calculating section 34.

Thus, the low pass filter 33 removes the acceleration α_{c}, which is generated due to the vibration of the PND supporter 3D around the support point 3C of the cradle 3, from the total acceleration α_{cz}, and thereby extracts only the acceleration α_{z}, which is generated due to the undulation of the road surface.

Moreover, the low pass filter 33 removes the angular velocity ω_{c}, which is generated due to the vibration of the PND supporter 3D around the support point 3C of the cradle 3, from the total angular velocity ω_{cy}, and thereby extracts only the pitch rate ω_{y}, which is generated due to the undulation of the road surface.

### 1-8. Autonomous Velocity Calculation

Next, autonomous velocity calculation performed by the velocity calculating section 34 will be described in detail. The velocity calculating section 34 calculates the autonomous velocity V on the basis of the acceleration data AD2 and the pitch rate data PD2 supplied by the low pass filter 33.

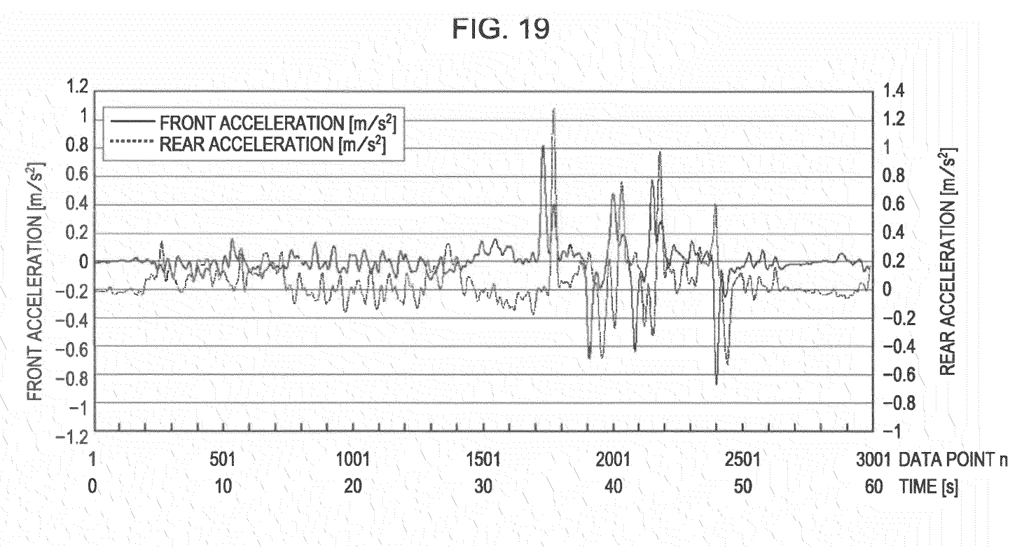

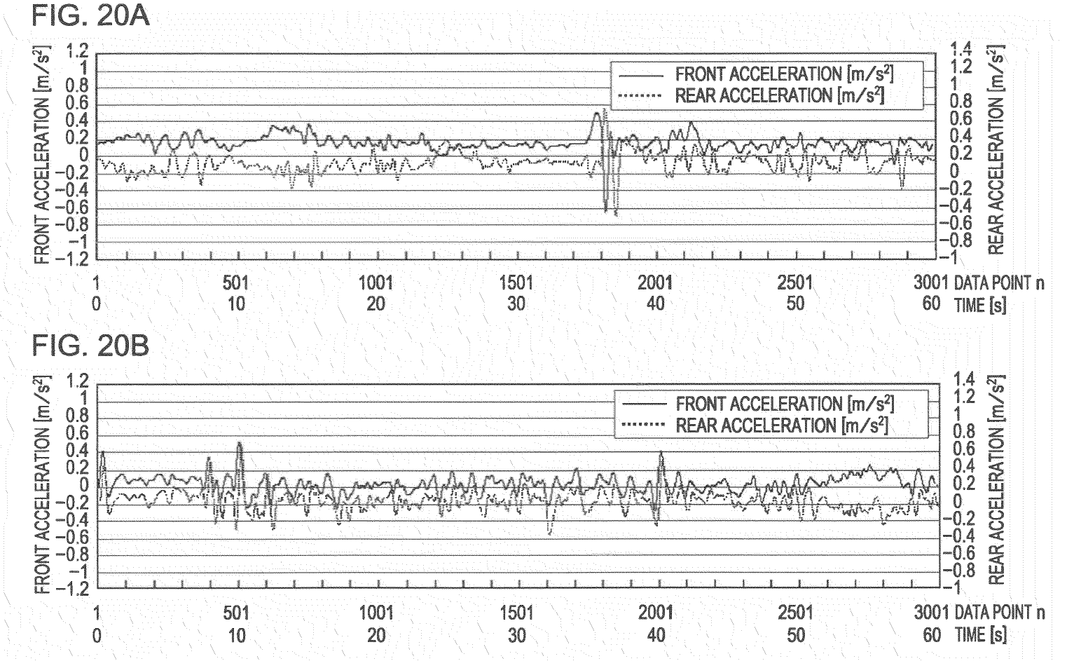

FIGS. 19, 20A, and 20B respectively illustrate the acceleration α_{z} corresponding to the acceleration data AD2, which is generated when the vehicle is traveling at a low velocity lower than 20 km/h, at a medium velocity equal to or higher than 20 km/h and lower than 60 km/h, and at a high velocity equal to or higher than 60 km/h. For each of the velocity ranges, a case in which the PND 1 is placed on the dashboard in a front part of the vehicle and a case in which the PND 1 is placed near to the rear window in a rear part of the vehicle are illustrated.

In FIGS. 19, 20A, and 20B, the acceleration α_{z} that is detected by the PND 1 placed in the front part of the vehicle is referred to as the front acceleration and the acceleration α_{z} that is detected by the PND 1 placed in the rear part of the vehicle is referred to as the rear acceleration.

As can be seen from FIGS. 19, 20A, and 20B, the phase of the rear acceleration is delayed with respect to the phase of the front acceleration irrespective of the velocity of the vehicle. This phase delay is approximately equal to the wheelbase divided by the velocity of the vehicle, the wheelbase being the distance between the front wheel axis and the rear wheel axis of the vehicle.

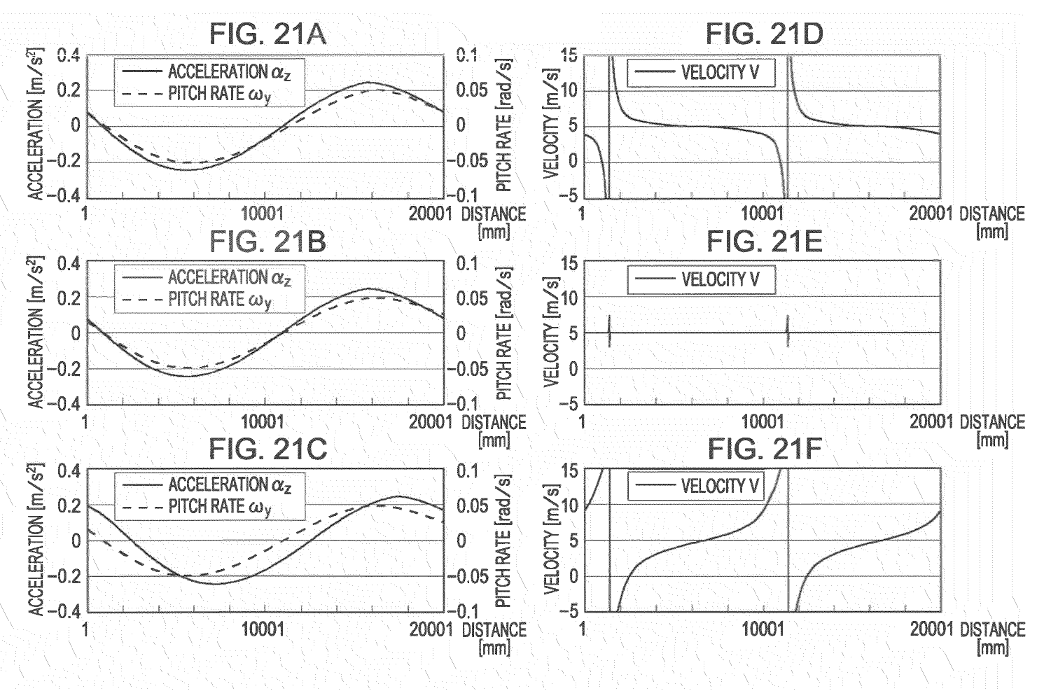

FIGS. 21A to 21C respectively illustrate an example of a simulation result representing the relationship between the acceleration α_{z} corresponding to the acceleration data AD2 and the pitch rate ω_{y} corresponding to the pitch rate data PD2 when the PND 1 is placed on the dashboard (at a position away from the front wheel axis by 30% of the wheelbase), at the center, and at a position above the rear wheel axis of the vehicle. FIGS. 21D to 21F illustrate the autonomous velocity V calculated using equation (1) on the basis of the acceleration α_{z} and the pitch rate ω_{y} obtained from the simulation result illustrated in FIGS. 21A to 21C.

In this simulation, it is assumed that a vehicle having a wheelbase of 2.5 m travels at a velocity of 5 m/s on a road surface having a sinusoidal undulation with an amplitude of 0.1 m and a wavelength of 20 m.

As can be seen from FIGS. 21A to 21C, the phase of the acceleration α_{z} is delayed when the position of the PND 1 is moved toward the back of the vehicle. In contrast, the phase of the pitch rate ω_{y} is not delayed irrespective of the position of the PND 1 on the vehicle.

Therefore, as illustrated in FIG. 21B, the phase difference between the acceleration α_{,} and the pitch rate ω_{y} is negligible when the PND 1 is placed at the center of the vehicle. Thus, as illustrated in FIG. 21E, the autonomous velocity V, which is calculated using equation (1), is substantially constant.

However, as illustrated in FIGS. 21A and 21C, when the position of the PND 1 is moved forward or backward from the center of the vehicle, the phase difference between the acceleration α_{z} and the pitch rate ω_{y} increases. Therefore, as illustrated in FIGS. 21D and 21F, due to the phase difference between the acceleration α_{z} and the pitch rate ω_{y}, the autonomous velocity V calculated using equation (1) has a larger error than the autonomous velocity V calculated when the PND 1 is placed at the center of the vehicle (FIG. 21E).

In particular, when the autonomous velocity V of the vehicle is lower than 20 km/h, the phase difference between the acceleration α_{z} and the pitch rate ω_{y} is large, so that the calculation error of the autonomous velocity V increases.

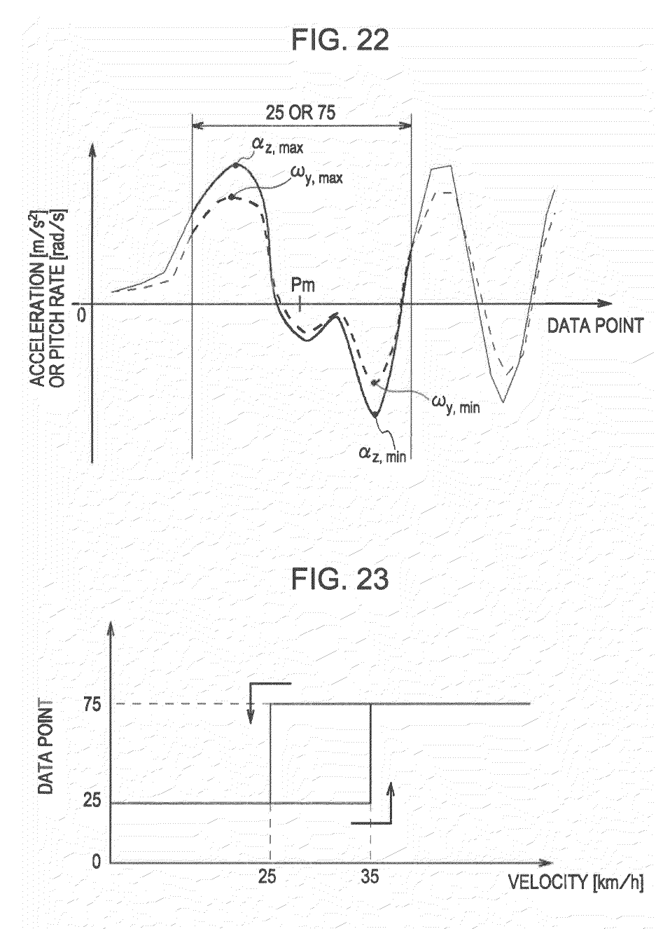

Therefore, referring to FIG. 22, the velocity calculating section 34 extracts the maximum value and the minimum value of the acceleration α_{z}, which corresponds to the acceleration data AD2 supplied by the low pass filter 33, from a range of 25 or 75 data points centered around a data point Pm that corresponds to the previous position P0 (FIG. 3). The maximum and minimum values will be referred to as the maximum acceleration α_{z,max} and the minimum acceleration α_{z,min}, respectively.

Moreover, the velocity calculating section 34 extracts the maximum value and the minimum value of the pitch rate ω_{y}, which corresponds to the pitch rate data PD2 supplied by the low pass filter 33, from a range of 25 or 75 data points centered around the data point Pm. The maximum and minimum values will be referred to as the maximum pitch rate ω_{y,max} and the minimum pitch rate ω_{y,min}, respectively.

That is, the velocity calculating section 34 extracts the maximum and minimum accelerations α_{z,max} and α_{z,min} and the maximum and minimum pitch rates ω_{y,max} and ω_{y,min} from a range that is larger than the largest possible phase difference that may be generated between the acceleration α_{z} and the pitch rate ω_{y}.

The velocity calculating section 34 calculates the autonomous velocity V in the direction of travel at the previous position P0 (FIG. 3) in accordance with the following equation (3), which is rewritten from equation (1), using the maximum and minimum accelerations α_{z,max} and α_{z,min}, which are extracted from the acceleration data AD2, and the maximum and minimum pitch rates ω_{y,max} and ω_{y,min}, which are extracted from pitch rate data PD2, to generate velocity data VD1, and sends the velocity data VD1 to the smoother/noise filter 35.

$$V = \frac{{α}_{z , max} - {α}_{z , min}}{{ω}_{y , max} - {ω}_{y , min}} \qquad ( 3 )$$

Thus, even when there is a phase difference between the acceleration α_{z} and the pitch rate ω_{y}, the velocity calculating section 34 can calculate, by using equation (3), the autonomous velocity V from which the effect of the phase delay is removed.

Referring to FIG. 23, when calculating the autonomous velocity V in the direction of travel at the previous position P0 while the vehicle is accelerating, the velocity calculating section 34 uses a range of 25 data points if the autonomous velocity Vₙ₋₁ at the second previous position (not shown) (hereinafter referred to as a former velocity) is in the range of 0 km/h to 35 km/h, and the velocity calculating section 34 uses a range of 75 data points if the former velocity Vₙ₋₁ is higher than 35 km/h.

When calculating the autonomous velocity V in the direction of travel at the previous position P0 while the vehicle is decelerating, the velocity calculating section 34 uses a range of 75 data points if the former velocity Vₙ₋₁ is equal to or higher than 25 km/h, and the velocity calculating section 34 uses a range of 25 data points if the former velocity Vₙ₋₁ is lower than 25 km/h.

Thus, the velocity calculating section 34 switches the data range between 25 data points and 75 data points in accordance with the autonomous velocity V when extracting the maximum and minimum accelerations a α_{z,max} and α_{z,min} and the maximum and minimum pitch rates ω_{y,max} and ω_{y,min}.

When the autonomous velocity V of the vehicle is equal to or lower than, for example, 25 km/h, the acceleration α_{z} and the pitch rate ω_{y} change sharply in response to a slight change in the road surface. Therefore, the velocity calculating section 34 uses a narrow data range in order to deal with a sharp change.

When the autonomous velocity of the vehicle is equal to or higher than 35 km/h, the influence of a suspension of the vehicle is large and the acceleration α_{z} and the pitch rate ω_{y} change slowly. Therefore, the velocity calculating section 34 sets a wide data range in order to deal with a slow change.

Thus, the velocity calculating section 34 changes the data range, from which the maximum and minimum accelerations α_{z,max} and α_{z,min} and the maximum and minimum pitch rates ω_{y,max} and ω_{y,min} are extracted, in accordance with the autonomous velocity V of the vehicle, so that the conditions of the road surface and the vehicle that change in accordance with the autonomous velocity V can be taken into account, whereby the autonomous velocity V can be calculated more precisely.

Moreover, when calculating the maximum and minimum accelerations α_{z,max} and α_{z,min} and the maximum and minimum pitch rates ω_{y,max} and ω_{y,min}, the velocity calculating section 34 changes the data range with a hysteresis between the case when the vehicle is accelerating and the case when the vehicle is decelerating.

Thus, frequency of changing of the data range around a switching velocity is reduced as compared to a case in which the velocity calculating section 34 calculates the autonomous velocity V by changing the data range without a hysteresis. As a result, the velocity calculating section 34 can reduce the calculation error of the autonomous velocity V that may occur due to frequent switching of the data range, whereby the autonomous velocity V can be calculated more precisely.

### 1-9. Smoothing and Noise Filtering

Next, smoothing and noise filtering performed by the smoother/noise filter 35 on the velocity data VD1, which has been calculated by the velocity calculating section 34, will be described in detail.

The smoother/noise filter 35 performs low pass filtering, which is first-order IIR with a variable cutoff frequency, on the velocity data VD1 supplied by the velocity calculating section 34.

To be specific, when calculating the autonomous velocity V in the direction of travel at the previous position P0, the smoother/noise filter 35 determines the cutoff frequency on the basis of the former velocity V.

When the velocity of the vehicle is equal to or higher than, for example, 60 km/h, the autonomous velocity V calculated by the velocity calculating section 34 of the PND 1 includes a large amount of noise, and thereby the autonomous velocity V considerably deviates. Therefore, the smoother/noise filter 35 uses a low pass filter having a low cutoff frequency when the former velocity Vₙ₋₁ is equal to or higher than 60 km/h.

In contrast, the smoother/noise filter 35 uses a low pass filter having a high cutoff frequency when the former velocity Vₙ₋₁ is lower than 60 km/h.

When the autonomous velocity V calculated by the velocity calculating section 34 is lower than, for example, 10 km/h, the pitch rate ω_{y}, which is the denominator of equation (1) or (3), may be small, so that the autonomous velocity V calculated using the equation (1) or (3) may become considerably higher than the real value.

Therefore, the smoother/noise filter 35 acquires the acceleration data AD2 and the pitch rate data PD2, which have been low pass filtered, from the low pass filter 33. If the pitch rate ω_{y} corresponding to the pitch rate data PD2 is lower than a predetermined threshold, the smoother/noise filter 35 determines that the autonomous velocity V is excessively high and sets the value of the autonomous velocity V, after being low pass filtered, at 0.

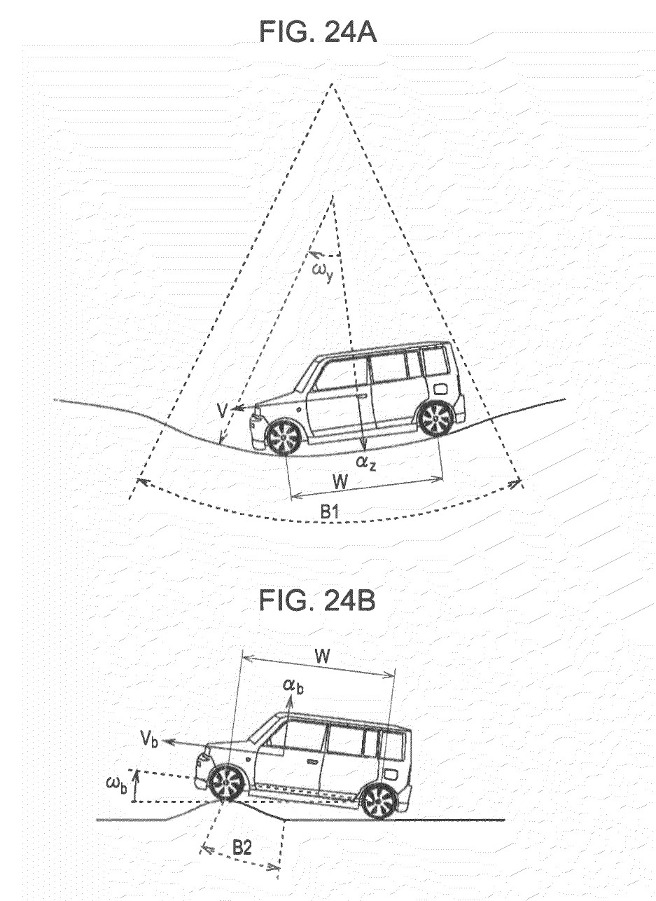

If an arc B1 of the undulation of a road surface is larger than the wheelbase W of the vehicle as illustrated in FIG. 24A, the PND 1 can accurately calculate the autonomous velocity V using the aforementioned fundamental principle.

However, if an arc B2 of the undulation of a road surface is smaller than the wheelbase W of the vehicle as illustrated in FIG. 24B, an acceleration α_{b} in a vertical direction of the vehicle and an angular velocity ω_{b} around the Y axis centered around the rear wheel of the vehicle are generated when the front wheel of the vehicle rolls over the undulation.

At this time, the three-axis acceleration sensor 4 and the Y axis gyro sensor 5 of the PND 1 detect the acceleration α_{b} and the angular velocity ω_{b} (FIG. 24B), instead of detecting the acceleration α_{z} and the pitch rate ω_{y} (FIG. 24A), which are generated by a vibration having a frequency in the range of 1 to 2 Hz due to the undulation of the road surface.

The acceleration α_{b} is larger than the acceleration α_{z}, which is generated when the arc B1 of the undulation of the road surface is larger than the wheelbase W of the vehicle. The angular velocity ω_{b} is higher than the pitch rate ω_{y}, which is generated when the arc B1 of the undulation of the road surface is larger than the wheelbase W of the vehicle.

A velocity V_{b} (hereinafter also referred to as a small-arc velocity) is calculated using equation (1) or (3) on the basis of the acceleration α_{b} and the angular velocity ω_{b}, which are generated when the arc B2 of the undulation of the road surface is smaller than the wheelbase W of the vehicle.

Because the acceleration α_{b} changes more than the angular velocity ω_{b} does, the velocity V_{b} is considerably higher than the autonomous velocity V, which is calculated using equation (1) or (3) on the basis of the acceleration α_{z} and the angular velocity ω_{y} generated when the arc B1 of the undulation of the road surface is larger than the wheelbase W of the vehicle.

Therefore, when the arc B2 of the undulation of the road surface is smaller than the wheelbase W of the vehicle, the velocity calculator 22 of the PND 1 calculates the small-arc velocity V_{b} using the acceleration α_{b} and the angular velocity ω_{b}, which leads to calculating the autonomous velocity V as an excessively high value.

The smoother/noise filter 35 acquires, from the low pass filter 33, the acceleration data AD2 and the pitch rate data PD2, which have been low pass filtered, and determines whether or not the acceleration α_{z} corresponding to the acceleration data AD2 and pitch rate ω_{y} corresponding to the pitch rate data PD2 are higher than predetermined thresholds.

If the acceleration α_{z} corresponding to the acceleration data AD2 and the pitch rate ω_{y} corresponding to the pitch rate data PD2 are higher than the predetermined thresholds, the smoother/noise filter 35 determines that the autonomous velocity V is excessively high and uses the former velocity Vₙ₋₁ instead of the autonomous velocity V that has been low pass filtered. That is, the smoother/noise filter 35 uses the former velocity Vₙ₋₁ if the autonomous velocity V is excessively high when the velocity of the vehicle is not very low, because it is likely that the autonomous velocity V is not accurate in such a case.

Thus, if the autonomous velocity V that has been low pass filtered is excessively high, the smoother/noise filter 35 sets the autonomous velocity V at 0 when the velocity of the vehicle is very low and sets the autonomous velocity V at the former velocity Vₙ₋₁ when the velocity of the vehicle is not very low, whereby the autonomous velocity V can be calculated more accurately.

### 1-10. Process of Position Calculation Using Autonomous Velocity Calculation

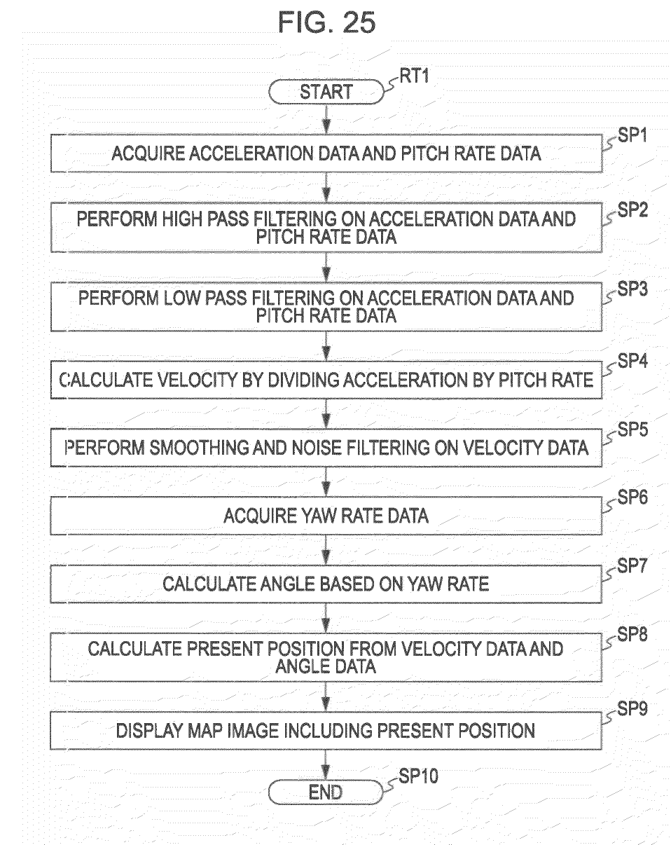

Referring to the flowchart of FIG. 25, a process of position calculation using the aforementioned autonomous velocity calculation, which is performed by the controller 11 of the PND 1, will be described.

The controller 11 starts the process from a start step of a routine RT1. In step SP1, the data acquirer 31 of the velocity calculator 22 acquires the acceleration data AD detected by the three-axis acceleration sensor 4 and the pitch rate data PD detected by the Y axis gyro sensor 5, and the controller 11 proceeds to step SP2.

In step SP2, the high pass filter 32 of the velocity calculator 22 of the controller 11 performs high pass filtering on the acceleration data AD and the pitch rate data PD, and the controller 11 proceeds to step SP3.

In step SP3, the low pass filter 33 of the velocity calculator 22 of the controller 11 performs low pass filtering, which is fourth-order IIR filtering with a cutoff frequency of, for example, 1 Hz, on the acceleration data AD1 and the pitch rate data PD1, which have been high pass filtered, and the controller 11 proceeds to step SP4.

In step SP4, the velocity calculating section 34 of the velocity calculator 22 of the controller 11 calculates the autonomous velocity V using equation (3) on the basis of the acceleration α_{z} corresponding to the acceleration data AD2 and the pitch rate ω_{y} corresponding to the pitch rate data PD2, which have been low pass filtered, and the controller 11 proceeds to step SP5.

In step SP5, the controller 11 performs smoothing and noise filtering on the velocity data VD representing the autonomous velocity V, which has been calculated in step SP4.

To be specific, the controller 11 performs low pass filtering having a variable cutoff frequency on the velocity data VD1 representing the autonomous velocity V, which has been calculated in step SP4.

If the controller 11 determines that the autonomous velocity V that has been low pass filtered is excessively high, the controller 11 sets the autonomous velocity V at 0 when the velocity of the vehicle is lower than, for example, 10 km/h and sets the autonomous velocity V at the former velocity Vₙ₋₁ when the velocity of the vehicle is equal to or higher than 10 km/h, and the controller 11 proceeds to step SP6.

In step SP6, the angle calculator 23 of the controller 11 acquires the yaw rate data YD detected by the Z axis gyro sensor 6, and the controller 11 proceeds to step SP7.

In step SP7, the angle calculator 23 of the controller 11 calculates the angle data DD representing the angle θ by multiplying the yaw rate ω_{z} corresponding to the yaw rate data YD by the sampling period 0.02 s, and the controller 11 proceeds to step SP8.

In step SP8, the controller 11 calculates the present position data NPD2 on the basis of the velocity data VD, on which smoothing and noise filtering have been performed in step SP5, and the angle data DD, which has been calculated in step SP7, and the controller 11 proceeds to step SP9.

In step SP9, the controller 11 reads from the memory 12 a map data including the present position of the vehicle on the basis of the present position data NPD2 supplied by the position calculator 25, generates a map image including the present position, and outputs the map image to the display 2, and the controller 11 proceeds to step SP10 where the process finishes.

### 1-11. Existing Process of Controlling Display of Present Position Mark

Before describing the process of controlling display of a present position mark performed by PND 1 according to the embodiment of the present invention, the process of controlling display of a present position mark performed by an existing PND in accordance with autonomous present position data that is autonomously calculated by using outputs of a general acceleration sensor and a general gyro sensor (or a general barometric pressure sensor, or the like) will be described.

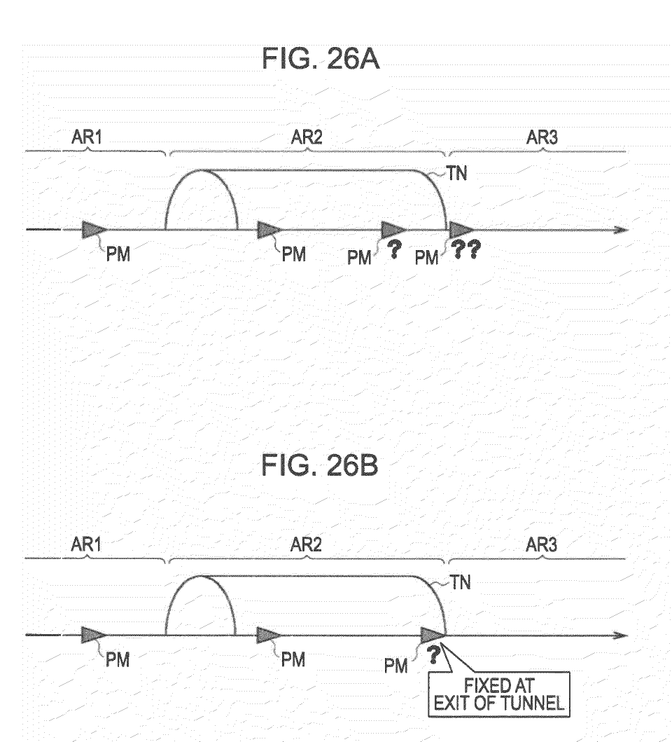

As illustrated in FIG. 26A, when the existing PND is in an area before a tunnel TN, in which GPS signals can be received with high sensitivity (hereinafter referred to as a GPS measurement area AR1), the existing PND measures GPS present position data and displays a present position mark PM on a map image in accordance with the GPS present position data.

Subsequently, when the vehicle enters the tunnel TN, which is an area in which it is difficult to receive GPS signals with high sensitivity (hereinafter referred to as a non-GPS measurement area AR2), the existing PND displays the present position mark PM based on autonomous present position data switched from the GPS present position data.

The autonomous present position data of the existing PND has a large calculation error, and the present position mark PM that is displayed in accordance with the autonomous present position data in the non-GPS measurement area AR2 becomes separated from the true present position.

As a result, with the existing PND, the present position marks PM just before the vehicle exits the tunnel TN and the present position mark PM just after the vehicle has exited the tunnel TN and moved to the GPS measurement area AR3 (indicated by “?” in FIG. 26A) do not necessarily indicate the true present position.

In such a case, as illustrated in FIG. 26B, if the existing PND continues to display the position mark PM in accordance with the autonomous present position data after the vehicle has entered the tunnel TN and moved to the non-GPS measurement area AR2, the present position mark PM overtakes the true present position.

Therefore, when the present position mark PM reaches a position near to the exit of the tunnel TN in accordance with the autonomous present position data, the present PND fixes the present position mark PM at the position so that the present position mark PM does not pass through the exit of the tunnel TN.

At this time, with the existing PND, the present position mark PM, which is fixed at a position near to the exit of the tunnel TN, becomes separated from the true present position at which the vehicle is traveling, so that the present position mark PM does not indicate the true present position.

### 1-12. Controlling Display of Present Position Mark According to Embodiment

The PND 1 according to the embodiment of the present invention controls display of a present position mark by using the present position data NPD2, which is calculated using the velocity data VD representing the autonomous velocity V calculated by the aforementioned calculation method and the angle data DD and which is more precise than the present position data used by the existing PND.

As described above, the controller 11 of the PND 1 can display the present position mark on a map image by using orbit data, which is obtained by demodulating GPS signals, and the present position data NPD1, which is measured on the basis of data on the distances between the GPS satellites and the vehicle.

When, for example, the vehicle is in a communication environment in which the GPS signals are unreceivable, such as a tunnel or an underground parking garage, the controller 11 of the PND 1 displays the present position mark on a map image by using the present position data NPD2, which is calculated on the basis of the aforementioned autonomous velocity V.

Thus, when the vehicle moves from a GPS measurement area to a non-GPS measurement area, the controller 11 of the PND 1 switches the present position data used for displaying the present position mark of the vehicle from the present position data NPD1 to the present position data NPD2.

Conversely, when the vehicle moves from a non-GPS measurement area to a GPS measurement area, the controller 11 of the PND 1 switches the present position data used for displaying the present position mark of the vehicle from the present position data NPD2 to the present position data NPD1.

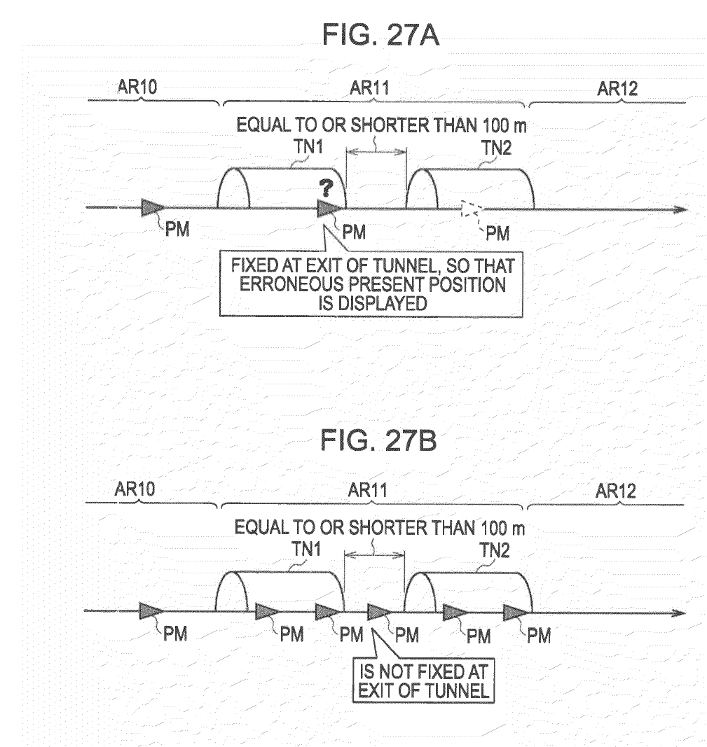

Referring to FIG. 27A, when the vehicle is in a GPS measurement area AR10 before a tunnel TN1, the controller 11 of the PND 1 displays the present position mark PM on a map image in accordance with the present position data NPD1.

Then, the vehicle enters the tunnel TN1 and moves from the GPS measurement area AR10 to a non-GPS measurement area AR11. The present position mark PM is displayed in accordance with the present position data NPD2, which is autonomously obtained, and reaches a position near to the exit of the tunnel TN1. If the controller 11 of the PND 1 fixes the present position mark PM at the position at this time, the following problem arises.

If the vehicle exits the tunnel TN1 and travels in a non-tunnel area that is shorter than, for example, 100 m, before entering the next tunnel TN2, it is difficult for the controller 11 of the PND 1 to receive GPS signals because the vehicle travels in the non-tunnel area for only a short time.

That is, for the PND 1, the area including the tunnel TN1, the non-tunnel area, and the tunnel TN2 is practically a non-GPS measurement area AR11, and the area beyond the exit of the tunnel TN2 is a GPS measurement area AR12.

When the vehicle has passed through the tunnel TN1, the controller 11 of the PND 1 should display the present position mark PM by switching to the present position data NPD1 measured on the basis of GPS signals. However, because the present position mark PM is fixed at the position near to the exit of the tunnel TN1, the present position mark PM becomes separated from the true present position (indicated by a broken line) by a large distance.

As illustrated in FIG. 27B, when the vehicle enters the tunnel TN1 and moves from the GPS measurement area AR10 to the non-GPS measurement area AR11, the controller 11 of the PND 1 displays the present position mark PM while advancing the present position mark PM in the tunnel TN1 in accordance with the present position data NPD2, which is autonomously obtained.

If a road between the exit of the tunnel TN1 and the entrance of the next tunnel TN2 is a non-tunnel area having a length equal to or shorter than 100 m, in which it is difficult to receive GPS signals, the controller 11 of the PND 1 performs display control in the following manner.

In the non-GPS measurement area AR11 including the tunnels TN1 and TN2, the controller 11 of the PND 1 dos not fix the present position mark PM at a position near to the exit of the tunnel TN1 and displays the present position mark PM while advancing the present position mark PM in accordance with the present position data NPD2, which is autonomously obtained.

Subsequently, when the vehicle has passed through the non-GPS measurement area AR11 including the tunnels TN1 and TN2 and moved to the GPS measurement area AR12, the controller 11 of the PND 1 switches the present position data that is used for displaying the present position mark PM from the present position data NPD2, which is autonomously obtained, to the present position data NPD1, which is measured on the basis of GPS signals.

In this case, the controller 11 of the PND 1 continuously displays the present position mark PM in the non-GPS measurement area AR11 by using the present position data NPD2, which is autonomously calculated using the aforementioned autonomous velocity V and having a high precision. Therefore, the PND 1 can indicate to a user the present position mark PM having an extremely small error as compared with existing PNDs even when the vehicle is in the tunnels TN1 and TN2.

### 1-13. Process of Controlling Display of Present Position Mark

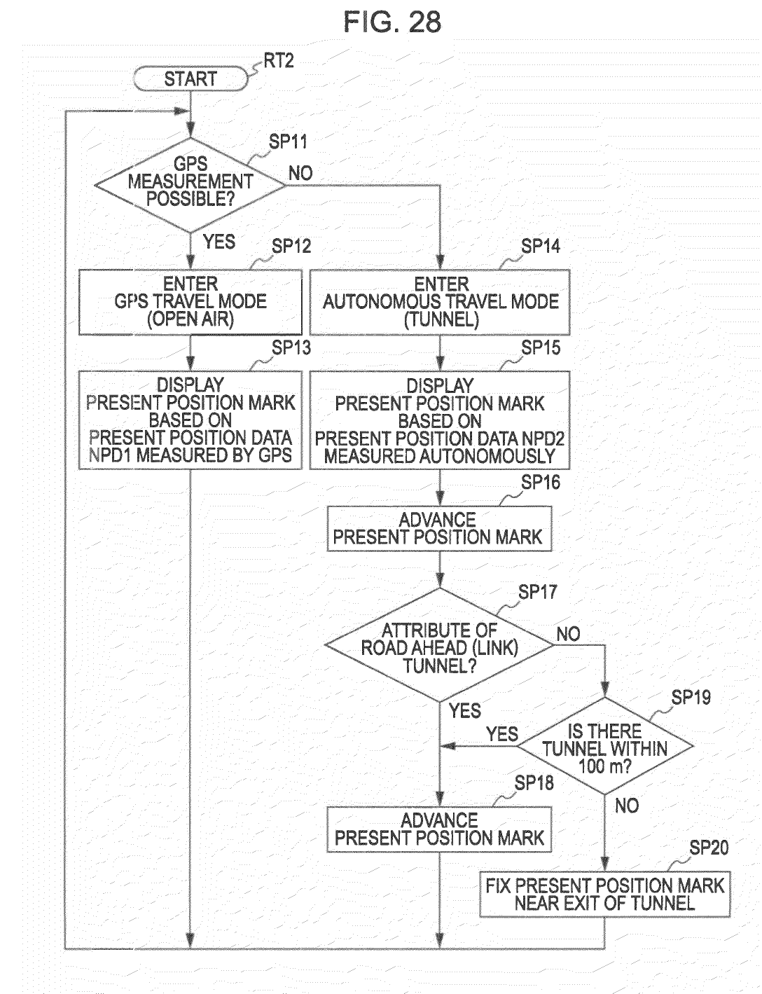

Referring to FIG. 28, the controller 11 of the PND 1 starts the process of displaying a present position mark from the start step of a routine RT2. In step SP11, the controller 11 determines, on the basis of attribute information of the present link, whether or not the vehicle is in the GPS measurement area AR10 and the present position is measurable using GPS signals. The term “link” refers to a unit area of a road that is divided by predetermined nodes.

If the determination is yes, the controller 11 enters a GPS travel mode (open air) that can display the present position mark PM in accordance with the present position data NPD1 measured on the basis of GPS signals, and the controller 11 proceeds to step SP13.

In step SP13, the controller 11 of the PND 1 displays the present position mark PM while moving the present position mark PM in accordance with the present position data NPD1 measured on the basis of GPS signals in the GPS measurement area AR10, and the controller 11 returns to step SP11.

If the determination in step SP11 is no, which means that it is difficult to measure the present position using GPS signals, i.e., the vehicle is in the tunnel TN1 and traveling in the non-GPS measurement area AR11, the controller 11 of the PND 1 proceeds to step SP14.

In step SP14, the controller 11 of the PND 1 enters an autonomous travel mode (tunnel) that can display the present position mark PM in accordance with the present position data NPD2, which is autonomously obtained, because the vehicle has entered the non-GPS measurement area AR11 including the tunnels TN1 and TN2, and the controller proceeds to step SP15.

In step SP15, the controller 11 of the PND 1 displays the present position mark PM on a map in accordance with the present position data NPD2, which is precisely calculated using the autonomous velocity V, and the controller 11 proceeds to step SP16.

In step SP16, the controller 11 of the PND 1 displays the present position mark PM on the map while advancing the present position mark PM in the non-GPS measurement area AR11 in accordance with the present position data NPD2, which is periodically calculated, and the controller proceeds to step SP17.

In step SP17, the controller 11 of the PND 1 reads attribute information about a link of the road that is next to the present link on which the vehicle is traveling and determines whether or not the attribute of the next link of the road is a tunnel.

If the determination is yes, which means that the next link of the road continues to be the tunnel TN1, the controller 11 of the PND 1 proceeds to step SP18.

In step SP18, the controller 11 of the PND 1 displays the present position mark PM on the map while advancing the present position mark in accordance with the present position data NPD2 because the road ahead continues to be the tunnel TN1, and the controller 11 returns to step SP11.

If the determination in step SP17 is no, which means that the road ahead is not the tunnel TN1, the controller 11 of the PND 1 proceeds to step SP19.

In step SP19, the controller 11 of the PND 1 determines whether or not the next tunnel TN2 is within 100 m from the tunnel TN1.

If the determination is no, which means that the next tunnel TN2 is more than 100 m away, the controller 11 of the PND 1 proceeds to step SP20.

In step SP20, the controller 11 of the PND 1 displays the present position mark PM while advancing the present position mark PM in accordance with the present position data NPD2. When the present position mark PM reaches a position near to the exit of the tunnel TN1, the controller 11 of the PND 1 fixes the present position mark PM at the position, and the controller returns to step SP11.

In this case, the controller 11 of the PND 1 can appropriately receive GPS signals in a non-tunnel area between the tunnels TN1 and TN2, which has a length larger than 100 m. Therefore, the non-tunnel area is a GPS measurement area, and the controller 11 of the PND 1 can display the present position mark PM while advancing the present position mark PM in accordance with the present position data NPD1.

When the present position mark PM has reached the position near to the exit of the tunnel TN1, the controller 11 of the PND 1 fixes the present position mark PM at the position and displays the present position mark PM. Because the present position mark PM is displayed in accordance with the present position data NPD2 having a high precision, the present position that has only a negligible error with respect to the true present position can be displayed.

In the non-tunnel area between the tunnel TN1 and the tunnel TN2, which is a GPS measurement area in which GPS signals can be received, the controller 11 of the PND 1 can display the present position mark PM in accordance with the present position data NPD1 measured on the basis of GPS signals, whereby the present position mark PM having a small error with respect to the true present position can be displayed.

Thus, when the vehicle is in the tunnel TN1, the controller 11 of the PND 1 can display the present position mark PM having a small error in accordance with the precise present position data NPD2, which is autonomously obtained. When the vehicle has passed through the tunnel TN1 to the non-tunnel area (GPS measurement area), the controller 11 of the PND 1 can display the present position mark PM having a small error in accordance with the present position data NPD1, which is obtained on the basis of the GPS signals.

If the determination in step SP19 is yes, which means that the tunnel TN2 is within 100 m from the TN1, the controller 11 of the PND 1 proceeds to step SP18.

In step SP18, the controller 11 of the PND 1 determines that the vehicle is in the non-GPS measurement area AR11 including the tunnels TN1 and TN2 and a non-tunnel area therebetween, because the non-tunnel area between the tunnel TN1 and the tunnel TN2 is shorter than 100 m and it is difficult to appropriately receive GPS signals.

For the controller 11 of the PND 1, the non-GPS measurement area AR11 includes the tunnels TN1 and TN2 and the non-tunnel area therebetween, and a road beyond the tunnel TN2 is the GPS measurement area AR12. Therefore, in the non-GPS measurement area AR11, the controller 11 of the PND 1 continuously displays the present position mark PM while advancing the present position mark in accordance with the present position data NPD2, which is autonomously obtained, without fixing the present position mark PM at a position near to the exit of the tunnel TN1, and the controller returns to step SP11.

In step SP11, the controller 11 of the PND 1 repeats the process after step SP11. Thus, even when the vehicle travels in a communication environment such as the GPS measurement area AR10, the non-GPS measurement area AR11, and the GPS measurement area AR12, the controller 11 of the PND 1 can display the present position mark PM having only a negligible error with respect to the true present position.

### 1-14. Operation and Effect

In the PND 1 having the structure described above, the three-axis acceleration sensor 4 detects the acceleration α_{z} along the Z axis perpendicular to direction of travel of the vehicle, which is generated due to the undulation of a road surface, and the Y axis gyro sensor 5 detects the pitch rate ω_{y} around the Y axis perpendicular to the direction of travel of the vehicle, which is generated due to the undulation of a road surface.

The PND 1 calculates the autonomous velocity V using equation (1) or (3) on the basis of the acceleration α_{z} detected by the three-axis acceleration sensor 4 and the pitch rate ω_{y} detected by the Y axis gyro sensor 5.

Thus, the PND 1, which has a simple structure including the three-axis acceleration sensor 4 and the Y axis gyro sensor 5, can accurately calculate the autonomous velocity V of the vehicle even when it is difficult for the PND 1 to receive GPS signals, and can precisely calculate the present position data NPD2 representing the present position of the vehicle on the basis of the autonomous velocity V and the yaw rate ω_{z} around the Z axis under all road conditions.

Moreover, when the vehicle enters the tunnel TN1 (FIG. 27B) and moves from the GPS measurement area AR10 to the non-GPS measurement area AR11, the PND 1 displays the present position mark PM while advancing the present position mark PM in the tunnel TN1 in accordance with the present position data NPD2, which is autonomously obtained.

When the area between the tunnel TN1 and the next tunnel TN2 is a non-tunnel area that is shorter than 100 m and in which it is difficult to receive GPS signals, the controller 11 of the PND 1 performs display control in the following manner.

That is, the controller 11 of the PND 1 dos not fix the present position mark PM in a position near to the exit of the tunnel TN1 in the non-GPS measurement area AR11. Instead, the controller 11 of the PND 1 displays the present position mark PM while advancing the present position mark PM in accordance with the present position data NPD2, which is autonomously obtained.

Subsequently, when the vehicle has passed through the non-GPS measurement area AR11 and moved to the GPS measurement area AR12, the controller 11 of the PND 1 switches the present position data that is used for displaying the present position mark PM from the present position data NPD2, which is autonomously obtained, to the present position data NPD1, which is measured on the basis of GPS signals.

Thus, the controller 11 of the PND 1 continuously displays the present position mark in the non-GPS measurement area AR11 by using the present position data NPD2, which is autonomously calculated using the aforementioned autonomous velocity V and has a high precision, so that the PND 1 can indicate to a user the present position mark PM having an extremely small error as compared with existing PNDs even when the vehicle is in the tunnels TN1 and TN2.

When the distance between the tunnel TN1 and the tunnel TN2 is shorter than 100 m and it is difficult to receive GPS signals when the vehicle is traveling at a high velocity, the controller 11 of the PND 1 does not switch the present position data from the present position data NPD2, which is autonomously obtained, to the present position data NPD1, which is obtained on the basis of GPS signals, and continuously displays the present position data PM in accordance with the present position data NPD2.

Thus, when the vehicle is the non-GPS measurement area AR11 including the tunnel TN1, the non-tunnel area, and the tunnel TN2, the controller 11 of the PND 1 can continuously and precisely display the present position data PM in accordance with the present position data NPD2, which is autonomously obtained, whereby the PND 1 can display the present position of the vehicle more precisely than existing PNDs.

With the above structure, the PND 1 can precisely display the present position of the vehicle with the present position mark PM in a communication environment in which GPS signals are unreceivable, such as the tunnels TN1 and TN2, or an environment in which it is difficult to receive GPS signals when the vehicle is traveling at a high velocity, such as an area that is between the tunnels TN1 and TN2 and shorter than 100 m.

### 2. Other Embodiments

In the above embodiment, the autonomous velocity V is calculated using equation (3) on the basis of the maximum and minimum accelerations α_{z,min} and a α_{z,max}, which are extracted from the acceleration α_{z} corresponding to the acceleration data AD2, and the maximum and minimum angular velocities ω_{y,max} and ω_{y,min}, which are extracted from the pitch rate ω_{y} corresponding to the angular velocity data DD2.

However, the present invention is not limited thereto. The velocity calculating section 34 may calculate the variances of the acceleration α_{z} corresponding to the acceleration data AD2 and the pitch rate ω_{y} corresponding to the pitch rate data PD2, which are supplied by the low pass filter 33, for, for example, a range of 25 data points or 75 data points around the data point Pₘ corresponding to the previous position P0. Then, the velocity calculating section 34 may calculate the autonomous velocity V by dividing the variance of the acceleration α_{z} by the variance of the pitch rate ω_{y}.

Alternatively, the velocity calculating section 34 may calculate the deviations of the acceleration α_{z} corresponding to the acceleration data AD2 and the pitch rate ω_{y} corresponding to the pitch rate data PD2, which are supplied by the low pass filter 33, for, for example, a range of 25 data points or 75 data points around the data point Pₘ corresponding to the previous position P0. Then, the velocity calculating section 34 may calculate the autonomous velocity V by dividing the variance of the acceleration α_{z} by the variance of the pitch rate ω_{y}.

In the above embodiment, the three-axis acceleration sensor 4, the Y axis gyro sensor 5, and the Z axis gyro sensor 6 respectively measure the accelerations αₓ, α_{y}, α_{z}, the pitch rates ω_{y}, and the yaw rate ω_{z} with a sampling frequency of 50 Hz. However, the present invention is not limited thereto. The three-axis acceleration sensor 4, the Y axis gyro sensor 5, and the Z axis gyro sensor 6 may respectively measure the accelerations αₓ, α_{y}, α_{z}, the pitch rates ω_{y}, and the yaw rate ω_{z} with a sampling frequency of, for example, 10 Hz instead of 50 Hz.

In the above embodiment, the autonomous velocity V is calculated using the acceleration α_{z} and the pitch rate ω_{y} that are detected with a sampling frequency of 50 Hz. However, the present invention is not limited thereto. The velocity calculator 22 of the PND 1 may calculate the averages of the acceleration α_{z} and the pitch rate ω_{y}, which are detected with a sampling frequency of 50 Hz, for, for example, every 25 data points, and may calculate the autonomous velocity V from the averages of the acceleration α_{z} and the pitch rate ω_{y}.

In this case, the velocity calculator 22 of the PND 1 calculates the averages of the acceleration α_{z} and pitch rate ω_{y}, which are detected with a sampling frequency of 50 Hz, for, for example, every 25 data points, thereby calculating the autonomous velocity V twice per second. Thus, a processing load for the controller 11 of the PND 1 due to autonomous velocity calculation can be reduced.

In the above embodiment, the high pass filter 32 and the low pass filter 33 perform high pass filtering and low pass filtering on the acceleration data AD and the pitch rate data PD, which have been detected by the three-axis acceleration sensor 4 and the Y axis gyro sensor 5. However, the present invention is not limited thereto. The PND 1 may perform, in addition to the high pass filtering and low pass filtering, moving average filtering on the acceleration data AD and the pitch rate data PD. The PND 1 may perform filtering that is an appropriate combination of high pass filtering, low pass filtering, and moving average filtering on the acceleration data AD and the pitch rate data PD.

In the embodiment described above, when calculating the autonomous velocity V at, for example, the previous position P0 using the acceleration α_{z} and the pitch rate ω_{y}, if it is determined that the autonomous velocity V at the previous position P0 is excessively high, the autonomous velocity V at the previous position P0 is set at the former velocity Vₙ₋₁. However, the present invention is not limited thereto. When it is determined that the autonomous velocity at the previous position P0 is excessively high, the velocity calculator 22 of the PND 1 may set the autonomous velocity V at a value that equals the former velocity Vₙ₋₁ at the previous position P0 plus a velocity that will be increased by acceleration of the vehicle.

When the autonomous velocity V at the previous position P0 is lower than the former velocity Vₙ₋₁ by a predetermined threshold, the velocity calculator 22 of the PND 1 may set the autonomous velocity V at the previous position P0 at a value that equals the former velocity Vₙ₋₁ minus a velocity that will be decreased by deceleration of the vehicle.

In the embodiment described above, the autonomous velocity V is calculated on the basis of the acceleration α_{z} and the pitch rate ω_{y} using equation (3).

However, the present invention is not limited thereto. The controller 11 of the PND 1 may compare the autonomous velocity V, which is calculated on the basis of the acceleration α_{z} and the pitch rate ω_{y} using equation (3), with the GPS velocity V_{g}, which is calculated on the basis of GPS signals.

When the autonomous velocity V has an error with respect to the GPS velocity V_{g}, the controller 11 of the PND 1 may calculate, for example, a correction factor for correcting the autonomous velocity V by using a linear function or a polynomial function of a second or a higher degree so as to minimize the error, and stores the correction factor in the memory 12.

Therefore, the velocity calculator 22 of the PND 1 may calculate the autonomous velocity V on the basis of the acceleration α_{z} and the pitch rate ω_{y} respectively detected by the three-axis acceleration sensor 4 and the Y axis gyro sensor 5 using equation (3), read the correction factor from the memory 12, and correct the autonomous velocity V using the correction factor and a linear function or a polynomial function of a second or a higher degree.

In this case, the PND 1 can more precisely calculate the autonomous velocity V by learning beforehand the correction factor for correcting the autonomous velocity V on the basis of the GPS velocity V_{g} calculated on the basis of GPS signals.

When calculating the correction factor used to correct the autonomous velocity V with respect to the GPS velocity V_{g}, the controller 11 of the PND 1 may divide the range of the autonomous velocity V into a plurality of velocity regions, such as a super low velocity region, a low velocity region, a medium velocity region, and a high velocity region, and may calculate a correction factor for each of the velocity regions.

When calculating the correction factor used to correct the autonomous velocity V with respect to the GPS velocity V_{g}, the controller 11 of the PND 1 may calculate the correction factor only when the vehicle is traveling at a high velocity that is equal to or higher than a predetermined value, such as 60 km/h.

In the above embodiment, the PND 1 performs navigation while the PND 1 is supplied with electric power. However, the present invention is not limited thereto. When the power button (not shown) is pressed and the PND 1 is powered off, the PND 1 may store, in the memory 12, the present position, the height, and the like at the moment when the power button is pressed. When the power button is pressed again and the PND 1 is powered on, the PND 1 may read the present position, the height, and the like from the memory 12, and may perform navigation on the basis of the present position, the height, and the like in accordance with the process of calculating the present position.

In the above embodiment, the PND 1 calculates the autonomous velocity V while the PND 1 is supported on the cradle 3 placed on the dashboard of the vehicle. However, the present invention is not limited thereto. When it is detected that the PND 1 is mechanically or electrically disconnected from the cradle 3, the autonomous velocity V may be set at 0 or maintained at the former velocity Vₙ₋₁.

In the above embodiment, the three-axis acceleration sensor 4, the Y axis gyro sensor 5, the Z axis gyro sensor 6, and the barometric pressure sensor 7 are disposed inside the PND 1. However, the present invention is not limited thereto. The three-axis acceleration sensor 4, the Y axis gyro sensor 5, the Z axis gyro sensor 6, and the barometric pressure sensor 7 may be disposed outside the PND 1.

The PND 1 may include an adjustment mechanism disposed on a side thereof so that a user can adjust the attachment angles of the three-axis acceleration sensor 4, the Y axis gyro sensor 5, the Z axis gyro sensor 6, and the barometric pressure sensor 7.

In this case, the PND 1 allows a user to adjust the adjustment mechanism so that, for example, the rotation axis of the Y axis gyro sensor 5 is aligned in the vertical direction with respect to the vehicle even when the display 2 is not substantially perpendicular to the direction of travel of the vehicle.

In the above embodiment, the autonomous velocity V is determined as excessively high if the pitch rate ω_{y} corresponding to the pitch rate data PD2 is lower than a predetermined threshold and if the acceleration α_{z} corresponding to the acceleration data AD2 and the pitch rate ω_{y} corresponding to the pitch rate data PD2 are higher than predetermined thresholds. However, the present invention is not limited thereto. The controller 11 may determine that the autonomous velocity V is excessively high if the autonomous velocity V calculated by the velocity calculating section 34 is higher than the former velocity Vₙ₋₁ by a predetermined value.

In this case, the smoother/noise filter 35 may set the autonomous velocity V at 0 when the autonomous velocity V calculated by the velocity calculating section 34 is higher than the former velocity Vₙ₋₁ by a predetermined value and when the former velocity is at a low velocity lower than, for example, 10 km/h. The smoother/noise filter 35 may set the autonomous velocity V at the former velocity Vₙ₋₁ when the autonomous velocity V calculated by the velocity calculating section 34 is higher than the former velocity Vₙ₋₁ by a predetermined value and the former velocity is equal to or higher than, for example, 10 km/h.

In the above embodiment, the controller 11 of the PND 1 performs the process of calculating the present position of the routine RT1 and the process of display control of the present position mark of the routine RT2 in accordance with application programs stored in the memory 12. However, the present invention is not limited thereto. The controller 11 of the PND 1 may perform the process of calculating the present position and the process of controlling display of the present position in accordance with application programs that are installed from storage media, downloaded from the Internet, or installed by using other methods.

In the embodiment described above, when the vehicle is traveling in the tunnel TN1 and TN2, the controller 11 of the PND 1 may recognize that the vehicle is in the non-GPS measurement area AR11 and continuously and precisely display the present position mark PM in accordance with the present position data NPD2, which is autonomously obtained. However, the present invention is not limited thereto. When the vehicle is traveling near to a position under an elevated highway or in an underground parking garage, the controller 11 of the PND 1 may realize that the vehicle is in the non-GPS measurement area AR11 on the basis of attribute information about the road that indicates a low reception sensitivity for GPS signals, and continuously and precisely display the present position mark PM in accordance with the present position data NPD2, which is autonomously obtained.

In the embodiment described above, in step SP20, the controller 11 of the PND 1 displays the present position mark PM while advancing the present position mark PM in accordance with the present position data NPD2 and, when the present position mark PM reaches a position near to the exit of the tunnel TN1, fixes the present position mark PM at the position. However, the present invention is not limited thereto. Because the present position data NPD2, which is autonomously measured, is more precise than that of existing NPDs, the controller 11 of the PND 1 may continuously display the present position mark PM in accordance with the present position data NPD2 without fixing the present position mark PM at the position near to the exit of the tunnel TN1.

In the description above, a navigation device according to an embodiment of the present invention is applied to the PND 1. However, the present invention is not limited thereto, and a navigation device according to an embodiment of the present invention may be applied to a mobile phone.

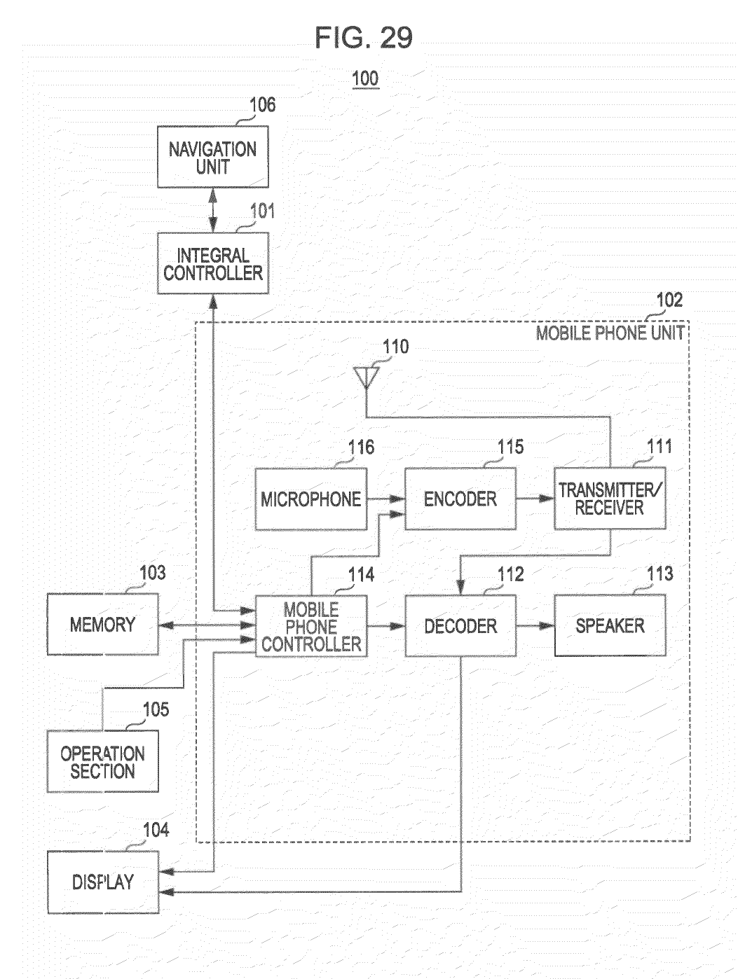

Referring to FIG. 29, a mobile phone 100 includes an integrated controller 101 and a mobile phone unit 102. The integrated controller 101 has a CPU structure and controls the function of the mobile phone unit 102 as a mobile phone.

The mobile phone 100 includes a navigation unit 106 that includes the controller 11, the three-axis acceleration sensor 4, the Y axis gyro sensor 5, the Z axis gyro sensor 6, and the barometric pressure sensor 7, which are illustrated in FIG. 7 and realize the navigation function of the PND 1. The integrated controller 101 controls the navigation unit 106. Description of the structure of the controller 11, which is the same as described above, is omitted.

The mobile phone 100 includes a memory 103, which is a semiconductor memory for storing various data, a display 104, which is a liquid crystal display (LCD) for displaying various information, and an operation section 105 having input buttons and the like.

In a normal mode, the mobile phone 100 uses the mobile phone unit 102 to perform a phone function and an email function. In practice, the mobile phone unit 102 of the mobile phone 100 receives a signal with an antenna 110 and sends the received signal to a transmitter/receiver 111.

The transmitter/receiver 111 includes a transmitter/receiver section that converts the received signal to a received data by demodulating the received signal, and sends the received data to a decoder 112. The decoder 112 reproduces the voice data of a person at the other end by decoding the received data under the control of a mobile phone controller 114 having a microcomputer structure, and outputs the voice data to a speaker 113. The speaker 113 outputs the voice of the person at the other end on the basis of the voice data.

The mobile phone unit 102 sends a voice signal collected by the microphone 115 to an encoder 116. The encoder 116 converts the voice signal to digital voice data and encodes the digital voice data by using a predetermined method under the control by the mobile phone controller 114, and sends the digital voice data to the transmitter/receiver 111.

The transmitter/receiver 111 modulates the digital voice data by using a predetermined method, and wirelessly transmits the modulated data from the antenna 110.

The mobile phone controller 114 of the mobile phone unit 102 displays the phone number of the person at the other end, the signal strength, and the like in accordance with an operation command sent from the operation section 105.

If the received data supplied by the transmitter/receiver 111 to the decoder 112 is an email, the mobile phone controller 114 of the mobile phone unit 102 send email data, which has been reproduced by decoding the received data, to the display 104 so as to display the email, and stores the email data in the memory 103.

When email data that is input through the operation section 105 is supplied, the mobile phone controller 114 of the mobile phone unit 102 encodes the email data using the encoder 116, and wirelessly sends the email data using the transmitter/receiver 111 and the antenna 110.

When the mobile phone 100 is in a navigation mode, the integrated controller 101 controls the navigation unit 106 and perform the process of controlling display of the present position mark display described above (FIG. 28).

In the embodiment described above, the present position mark PM is displayed by using the present position data NPD2, which is more precise than present position data used in existing PNDs. The NPD2 is calculated by using the velocity data VD representing the autonomous velocity V, which is calculated in accordance with the method of calculating the autonomous velocity, and the angle data DD. However, the present invention is not limited thereto. The present position mark PM may be displayed by using present position data that is autonomously calculated by using an appropriate method, as long as the present position data is as precise as the present position data NPD2. An example of the method is to calculate the present position by using the acceleration of the vehicle in a direction perpendicular to the direction of travel and an angular velocity around a vertical axis that is perpendicular to the direction of travel.

In the embodiment described above, the PND 1, which corresponds to a navigation device according to the present invention, includes the GPS processor 21 corresponding to position measuring means, the navigator 26 corresponding to map displaying means and present position notifying means, the velocity calculator 22 and the position calculator 25 corresponding to estimated present position acquiring means, and the navigator 26 corresponding to control means. However, the present invention is not limited thereto. A navigation device according to the present invention may include position measuring means, map displaying means, present position notifying means, estimated present position acquiring means, and control means, which have different structures.

The present application contains subject matter related to that disclosed in Japanese Priority Patent Application JP 2009-213448 filed in the Japan Patent Office on Sep. 15, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A navigation device comprising:
position measuring means that measures a present position on the basis of satellite signals received from satellites;
map displaying means that reads a local map including the present position from storage means and displays the local map on display means;
present position notifying means that generates a mark and displays the mark on the local map, the mark representing the present position and having a predetermined shape;
estimated present position acquiring means that acquires an estimated present position by estimating the present position in a communication environment in which the satellite signals are unreceivable; and
control means that reads attribute information about a next link that is next to a present link including the present position and, if the control means determines that the next link is an area in which a reception sensitivity for the satellite signals is low, does not fix the mark and continuously displays the mark on the local map in accordance with the estimated present position instead of using the present position measured by the position measuring means after the present position has moved from the present link to the next link.

2. The navigation device according to claim 1,
wherein the control means displays the present position mark on the local map by using the present position measured by the position measuring means if the control means determines that the present link is an area in which the reception sensitivity for the satellite signals is low and the next link is not an area in which the reception sensitivity for the satellite signals is low.

3. The navigation device according to claim 2,
wherein, if the control means determines that the next link is not an area in which the reception sensitivity for the satellite signals is low and if the area extends by a predetermined distance or more, the control means fixes the mark at a position near to an end of the present link and displays the mark at the position in accordance with the estimated present position until the present position advances to the next link.

4. The navigation device according to claim 2,
wherein, if the control means determines that the next link is not an area in which the reception sensitivity for the satellite signals is low and if the area does not extend by a predetermined distance or more, the control means does not fix the mark and continuously displays the mark on the local map in accordance with the estimated present position estimated by the present position estimating means until the present position advances to the next link.

5. The navigation device according to claim 1,
wherein, when the control means recognizes that the next link is a tunnel by reading the attribute information about the next link, the control means determines that the next link is an area in which the reception sensitivity for satellite signals is low.

6. The navigation device according to claim 1,
wherein, when the control means recognizes that the next link is near to a position under an elevated structure by reading the attribute information about the next link, the control means determines that the next link is an area in which the reception sensitivity for satellite signals is low.

7. A navigation method comprising the steps of:
measuring a present position on the basis of satellite signals received from satellites by using predetermined position measuring means;
reading a local map including the present position from storage means and displaying the local map on display means by using predetermined map reading means;
generating and displaying a mark on the local map by using predetermined present position notifying means, the mark representing the present position and having a predetermined shape;
acquiring an estimated present position by estimating the present position by using predetermined estimated present position acquiring means in a communication environment in which the satellite signals are unreceivable; and
performing control, by using predetermined control means, so as to read attribute information about a next link next to a present link including the present position and, if the control means determines that the next link is an area in which a reception sensitivity for the satellite signals is low, so as not to fix the mark and so as to continuously display the mark on the local map in accordance with the estimated present position instead of using the present position measured by the position measuring means after the present position has moved from the present link to the next link.

8. A mobile phone having a navigation function, the mobile phone comprising:
a mobile phone unit; and
a navigation device including
position measuring means that measures a present position on the basis of satellite signals received from satellites,
map displaying means that reads a local map including the present position from storage means and displays the local map on display means,
present position notifying means that generates a mark and displays the mark on the local map, the mark representing the present position and having a predetermined shape,
estimated present position acquiring means that acquires an estimated present position by estimating the present position in a communication environment in which the satellite signals are unreceivable, and
control means that reads attribute information about a next link that is next to a present link including the present position and, if the control means determines that the next link is an area in which a reception sensitivity for the satellite signals is low, does not fix the mark and continuously displays the mark on the local map in accordance with the estimated present position instead of using the present position measured by the position measuring means after the present position has moved from the present link to the next link.

9. A navigation device comprising:
a position measuring section that measures a present position on the basis of satellite signals received from satellites;
a map displaying section that reads a local map including the present position from a storage section and displays the local map on a display section;
a present position notifying section that generates a mark and displays the mark on the local map, the mark representing the present position and having a predetermined shape;
an estimated present position acquiring section that acquires an estimated present position by estimating the present position in a communication environment in which the satellite signals are unreceivable; and
a control section that reads attribute information about a next link that is next to a present link including the present position and, if the control means determines that the next link is an area in which a reception sensitivity for the satellite signals is low, does not fix the mark and continuously displays the mark on the local map in accordance with the estimated present position instead of using the present position measured by the position measuring section after the present position has moved from the present link to the next link.

10. A mobile phone having a navigation function, the mobile phone comprising:
a mobile phone unit; and
a navigation device including
a position measuring section that measures a present position on the basis of satellite signals received from satellites,
a map displaying section that reads a local map including the present position from a storage section and displays the local map on a display section,
a present position notifying section that generates a mark and displays the mark on the local map, the mark representing the present position and having a predetermined shape,
an estimated present position acquiring section that acquires an estimated present position by estimating the present position in a communication environment in which the satellite signals are unreceivable, and
a control section that reads attribute information about a next link that is next to a present link including the present position and, if the control means determines that the next link is an area in which a reception sensitivity for the satellite signals is low, does not fix the mark and continuously displays the mark on the local map in accordance with the estimated present position instead of using the present position measured by the position measuring section after the present position has moved from the present link to the next link.
